(19) United States
(12) Patent Application Publication
(10) Pub. No.: US 2015/0111010 A1
(43) Pub. Date: Apr. 23, 2015

(54) TAPE COMPRISING MULTI-ACTIVATION ADHESIVES

(71) Applicant: H.B. FULLER COMPANY, St. Paul, MN (US)

(72) Inventors: Jorge A. Nash, Vancouver, WA (US); Dennis A. Bradshaw, Damascus, OR (US); Justine Hanlon, Vancouver, WA (US); Kelby V. Ridenour, Portland, OR (US); Bruce J. Shreeve, Portland, OR (US); Patrick D. Gleason, Shoreview, MN (US)

(73) Assignee: H.B. FULLER COMPANY, St. Paul, MN (US)

(21) Appl. No.: 14/059,080

(22) Filed: Oct. 21, 2013

(51) Int. Cl. C09J 7/02

(52) U.S. Cl. CPC C09J 7/0203; C09J 2201/61; C09J 2201/40
USPC 428/200; 427/208.2

(57) ABSTRACT

An adhesive tape or string, comprising:
a substrate having a first surface and an opposing second surface, and defining a longitudinal direction; and
an adhesive system comprising at least a first adhesive section and a second adhesive section, wherein the first adhesive section and the second adhesive section each contact the first surface of the substrate, and wherein the first adhesive section comprises a first heat-activatable hot melt adhesive having a first activation temperature range and a first set time and the second adhesive section comprises a second heat-activatable hot melt adhesive having a second activation temperature range and a second set time, and wherein:
the first activation temperature range is different than the second activation temperature range; or
the first set time is different than the second set time; or
the first activation temperature range is different than the second activation temperature range and the first set time is different than the second set time.

### BACKGROUND

Corrugated paper board substrates, such as those used in corrugated boxes, are produced by a system known as a corrugator. Three large rolls of paper are necessary to produce single-wall corrugated paper board substrate. One forms the corrugated medium, and the other two form the liner boards on either side of the medium. The top board is normally called the single-face liner board, and the bottom layer often called a double-face liner board. The reinforcing and opening tapes disclosed in this invention are applied to the outside surface of the single-face liner board and/or between the corrugated medium and double-face liner board.

The manufacture of quality corrugated paper board substrates require tight controls in process temperatures and line speed. These process controls vary widely depending on the corrugator's paperboard construction such as number of walls, gauge of liners and medium, flute type, and corrugator machine type. Pre-coated hot melt reinforcement and opening tapes are activated and set by this same tightly controlled corrugators system temperatures and line speed to the paperboard substrate. As a first example, a single wall B flute paper board substrate may be processed at 190 F applied to the double-face liner board at line speed of 1,000 fpm requiring a pre-coated hot melt adhesive tape that activates at 190 F and set fast (function of line speed). As a second example, a double-wall B flute paperboard substrate may be processed at 230 F on the double-face liner board at line speed of 500 fpm requiring a pre-coated hot melt adhesive tape that activates at 230 F and sets slow (again function of line speed). The pre-coated reinforcing and opening tapes disclosed herein overcomes the need for having distinctly different formulated tapes for different paperboard constructions and corrugators machine types.

### SUMMARY

Disclosed herein is an adhesive tape or string, comprising:
a substrate having a first surface and an opposing second surface, and defining a longitudinal direction; and
an adhesive system comprising at least a first adhesive section and a second adhesive section, wherein the first adhesive section and the second adhesive section each contact the first surface of the substrate, and wherein the first adhesive section comprises a first heat-activatable hot melt adhesive having a first activation temperature range and a first set time and the second adhesive section comprises a second heat-activatable hot melt adhesive having a second activation temperature range and a second set time, and wherein:
the first activation temperature range is different than the second activation temperature range; or
the first set time is different than the second set time; or
the first activation temperature range is different than the second activation temperature range and the first set time is different than the second set time.

Additionally disclosed herein is an adhesive tape or string for use in a corrugator system, comprising:
a substrate having a first surface and an opposing second surface, and defining a longitudinal direction; and
an adhesive system comprising at least a first adhesive section and a second adhesive section, wherein the first adhesive section and the second adhesive section are each disposed on the first surface of the substrate, and wherein the first adhesive section comprises a first heat-activatable adhesive that can bond to a corrugated board substrate at a first temperature applied by the corrugator system, and a second heat-activatable adhesive that can bond to a corrugated board substrate at a second temperature applied by the corrugator system, wherein the first temperature is different than the second temperature.

Also disclosed herein is a container comprising:
at least one panel or flap configured to at least partially form a bottom or at least one wall of the container, wherein the panel or flap comprises a corrugated paper board, and the panel or flap includes an inside surface and an outside surface; and
at least one tape or string as disclosed herein adhesively affixed to at least one panel or flap of the container.

Further disclosed is a reinforced paper board construct, comprising:
a paper board substrate; and
at least one tape or string as disclosed herein adhesively affixed to the paper board substrate.

Additionally disclosed is a tear opening system for a paper board construct, comprising:
a paper board substrate defining a first surface and a second surface;
at least one tear tape disposed on at least one of the first surface or the second surface of the paper board substrate, wherein the tear tape is a tape as disclosed herein; and
a tear-initiating element associated with the tear tape and the paper board substrate.

Further disclosed herein is a container comprising:

at least one side wall panel comprising a corrugated board substrate, wherein the side wall panel defines an exterior surface and an interior surface; and

a tear opening system, wherein the tear opening system comprises:
(i) a tear tape adhesively secured to the interior surface of the side wall panel, wherein the tear tape is a tape as disclosed herein; and
(ii) a tear-initiating element located on the tear tape.

Also disclosed herein is a method for applying a tape or string to a paper board substrate, comprising
applying the tape or string of as disclosed herein to a paper board substrate, and heating the tape so as to adhesively affix the tape to the paper board substrate.

The foregoing will become more apparent from the following detailed description, which proceeds with reference to the accompanying figures.

### BRIEF DESCRIPTION OF THE DRAWINGS

FIG. 1A is a perspective view of a cross-section of one embodiment of a tape disclosed herein. The view of FIG. 1A is from line A-A as shown in FIGS. 1B and 1C.

FIG. 1B is a perspective view of one embodiment of a tape roll as disclosed herein.

FIG. 1C is a perspective view of another embodiment of a tape roll as disclosed herein.

FIGS. 1D, 1E, 1F, 1G, 1H and 1I are exploded views of a portion of the tape substrate shown in FIG. 1A.

FIG. 2 is a perspective view of a cross-section of one embodiment of tape disclosed herein. The view of FIG. 2 is from line A-A as shown in FIGS. 1B and 1C.

FIG. 3 is a perspective view of a cross-section of one embodiment of tape disclosed herein. The view of FIG. 3 is from line A-A as shown in FIGS. 1B and 1C.

FIG. 4 is a perspective view of a cross-section of one embodiment of tape disclosed herein. The view of FIG. 4 is from line A-A as shown in FIGS. 1B and 1C.

FIG. 5 is a perspective view of a cross-section of one embodiment of tape disclosed herein. The view of FIG. 5 is from line A-A as shown in FIGS. 1B and 1C.

FIG. 6A is a perspective view of a first embodiment of a paper board substrate that is partially torn via a tear tape opening system as disclosed herein.

FIG. 6B is an exploded view of a portion of the paper board substrate shown in FIG. 6A.

FIG. 7A is a perspective view of second embodiment of a paper board substrate that is partially torn via a tear tape opening system as disclosed herein.

FIG. 7B is an exploded view of a portion of the paper board substrate shown in FIG. 7A.

FIG. 8A is a perspective view of third embodiment of a paper board substrate that is partially torn via a tear tape opening system as disclosed herein.

FIG. 8B is an exploded view of a portion of the paper board substrate shown in FIG. 8A.

FIG. 8C is an exploded perspective view of a portion of the paper board substrate shown in FIG. 8A.

FIG. 9A is a perspective view of one embodiment of a paper board substrate with a reinforcement tape as disclosed herein.

FIG. 9B is an exploded view of a portion of the paper board substrate shown in FIG. 9A.

FIG. 10A is a perspective view of another embodiment of a paper board substrate with a reinforcement tape as disclosed herein.

FIG. 10B is an exploded view of a portion of the paper board substrate shown in FIG. 10A.

FIG. 11A is a top view of one embodiment of a process for making the tape embodiments disclosed herein.

FIG. 11B is a side view of one embodiment of a process for making the tape embodiments disclosed herein.

FIG. 12A is a top view of another embodiment of a process for making the tape embodiments disclosed herein.

FIG. 12B is a side view of another embodiment of a process for making the tape embodiments disclosed herein.

FIG. 12C is a top view of another embodiment of a process for making the tape embodiments disclosed herein.

FIG. 12D is a side view of another embodiment of a process for making the tape embodiments disclosed herein.

FIG. 13A is a perspective view of a cross section of a paper board substrate and a tape as disclosed herein.

FIG. 13B is a side view of a process for making the paper board substrate/tape embodiment of FIG. 13A.

FIG. 14A is a perspective view of a cross section of one embodiment of a paper board substrate and a reinforcement tape disclosed herein.

FIG. 14B is a side view of a process for making the paper board substrate/tape embodiment of FIG. 14A.

FIG. 15A is a perspective view of a cross section of one embodiment of a paper board substrate and a two tape opening system as disclosed herein.

FIG. 15B is a side view of a process for making the paper board substrate/tape embodiment of FIG. 15A.

FIG. 16 is a perspective view of a container that includes a tear tape system as disclosed herein.

FIG. 17 is a perspective view of a container that includes reinforcement tape as disclosed herein.

FIGS. 18A, 18B, 18C, and 18D are a perspective views of containers that includes hand hole reinforcement tape as disclosed herein.

FIG. 19A is a perspective view of a cross section of one embodiment of a paper board substrate and a two tape opening system as disclosed herein.

FIG. 19B is a side view of a process for making the paper board substrate/tape embodiment of FIG. 19A.

### DETAILED DESCRIPTION

Disclosed herein are tapes or strings that include at least two different heat-activatable adhesives each of different compositions that have different activation temperature ranges. The tapes or strings allow for the use of a single tape product on a paper board substrate corrugator system operating at variable processing temperatures and line speeds. For example, the tape product may be introduced into a corrugator system that initially runs at a first processing temperature (e.g., anywhere within a range of 40-60° C.) for making a first paper board substrate. The corrugator system may then be re-set to run at a different processing temperature (e.g., anywhere within a range of 100-120° C.) for making a second paper board substrate that is different than the first paper board substrate but using the same tape as supplied for the first paper board substrate. In addition, a particular corrugator product run may have a processing temperature range or window. Since the presently disclosed tapes or strings include at least two different sets of activation temperature range values, the same tape or string may be introduced into the corrugator system for each of the processing temperatures. In other words, the corrugator system has the flexibility of producing different paper board substrates that require different processing temperatures without the operator changing the type of tape product for each processing temperature.

The corrugator line speed can also vary. For example, at start-up the line speed is slow but then the line speed increases up to full production line speed. Even at full production line speed there may be variability of the line speed within a desired line speed window. The tapes disclosed herein may have at least two different adhesive sections, each of which has a different adhesive set time range compared to each other. In certain embodiments, at least one of the adhesive set times is equal to or less than the corrugated board “dwell time” as explained below in more detail.

Furthermore, the tapes or strings disclosed herein allow continuous operation of a corrugator even if there are process deviations outside the desired operating limits of the corrugator processing speed or conditions. As is common in the corrugated industry, speed to market or completing quality corrugated board in a timely manner is a competitive issue and anything that impedes on the corrugator's ability to run board is a detractor. The tapes or strings disclosed herein enables a corrugator to run board within a wide operating range that allows more flexibility at start-stops and changeovers.

The presently disclosed tapes or strings permit operating a corrugator at broad temperature ranges and speeds using a single type of tape product.

The tape or string substrate may be in the form of a woven or nonwoven web, a film (including a fiber reinforced film), a multifilament yarn, a monofilament, a cellulosic substrate, or any combination thereof. The web, film or fiber may comprise polyester, polypropylene, polyethylene, polyamide (e.g., aromatic polyamide such as KEVLAR fiber from E.I. du Pont or nonaromatic polyamide such as nylon), fiberglass, natural fibers such as cotton or hemp, and/or other similar materials and combinations thereof. The substrate may be a cellulosic material selected from paper, a paper/polymeric film laminate, or a fiber-reinforced paper. The fibers of the substrate may be continuous strands (e.g., a multifilament yarn or a monofilament) unidirectionally oriented in a direction parallel to the length of the tape. In certain embodiments the fibrous material is polyester fiber. In certain embodiments, the fibrous material has a denier of 300 to 1100 per mm of tape width.

In certain embodiments, the tape has a tensile strength of at least 3 kg/mm of tape width, more particularly at least 15 kg/mm tape width, and most particularly at least 34 kg/mm tape width, per 11 mm width of tape or 3 kg/mm of tape width. In certain embodiments the tape has a weft strength of at least 0.5 kg, more particularly at least 0.9 kg. In certain embodiments the tape applied to a paper board substrate may have a peel strength sufficient to result in paper tear of the paper board substrate (e.g., a minimum peel strength of at least 20 kg/mm). The tape may be nick or puncture resistant because the tens, hundreds, or thousands of individual fiber strands prevent propagation of an initial nick or puncture. In certain embodiments, the tape may have a total basis strand weight of 1.10 to 2.50, more particularly 1.20 to 2.00, and most particularly 1.30 to 1.90, g/linear m based on an 11 mm tape width. In certain embodiments, the tape may have a thickness of 0.15 to 0.68 mm, more particularly 0.20 to 0.49 mm, prior to adhesion to the paper board. In some embodiments, the tape can have a length longer than its width. In other words, the tape defines a longitudinal axis along a longitudinal direction. In specific embodiments, the width of the tape is 3 mm to 35 mm, more particularly 11 mm to 20 mm, and most particularly 12 to 19 mm.

The tape may be made by applying the adhesives in a molten state to the tape substrate while the substrate is under tension at a controlled speed as described in more detail below. The molten adhesive(s) are allowed to cool and set up as a solid forming a linear unitized tape. The tape production process may include any heating methods known for applying hot melt adhesives.

The adhesives used on the tape or string are heat-activatable adhesives, particularly heat-activatable hot melt adhesives. In certain embodiments, the adhesive is not a pressure sensitive adhesive (i.e. an adhesive that is tacky at room temperature (i.e., 20°-25° C.)). A pressure sensitive adhesive, which is known to have an infinite open time, would need a release agent (e.g., powder, coating or film) in order to keep from blocking when in a string or tape form. Blocking occurs when an adhesive bonds two substrates irreversibly to one another.

One of the known benefits of certain thermoplastic hot melts as disclosed herein is the ability to be dispensed and cooled without a release agent. Once certain thermoplastic hot melt adhesives have set up or are solidified they tend to have very little tendency to block which sets them apart from pressure sensitive adhesives which require a release agent in order to form a dispensable tape product.

Multiple hot melt adhesives of different compositions and properties arranged on the same surface of a tape substrate provide synergistic advantages that are more than the sum of the individual adhesives by themselves. In addition, hot melt adhesives have a tendency to “bleed” together when they are adjacent to each other, but the configurations and processes of manufacture disclosed herein eliminate or substantially minimize the “bleed” together problem. For example, if a first hot melt adhesive composition is adjacent to a second hot melt adhesive composition and the first and second compositions bleed or melt together to form a combined composition, the combined composition will have poor adhesive characteristics. In certain embodiments, the multiple adhesives are incompatible with each other to the extent that they do not mix or blend into each other in the molten state.

In certain embodiments, the tape or string includes an adhesive system comprising at least a first adhesive section and a second adhesive section, wherein the first adhesive section and the second adhesive section each contact the first surface of the substrate, and wherein the first adhesive section comprises a first heat-activatable hot melt adhesive having a first activation temperature range and the second adhesive section comprises a second heat-activatable hot melt adhesive having a second activation temperature range that is different than the first activation temperature range. Activation temperature range is meant to describe a set of temperature values between a high temperature limit and a low temperature limit at which the adhesive is an activated state. Activation is a temperature range that allows a hot melt adhesive to reversibly transition from a solid inert state to a state of semi-liquidity wherein substrate penetration and bonding can occur. The adhesive may be active over the entire set of temperature values of a given activation temperature range. The tape also has a combined activation temperature range that is due to the nature of putting two different adhesive compositions adjacent to each other rather than blending them into a single composition, and the combined activation range will be larger than any single adhesive can achieve. Activation temperature range may be measured through quantitative and qualitative methods. The qualitative method is measured on a gradients bar for tack. Observation of the transition state determines activation temperature range. The quantitative method involves verification by peel/sheer strength and softening point.

The activation temperature range for each adhesive section may be designed as appropriate to match the possible variable processing temperatures in a corrugator system. In certain embodiments, the low temperature end point of the activation temperature range may be 2-4° C. less than the lowest tack temperature of the adhesive. In certain embodiments, the high temperature end point of the activation temperature range may be 2-10° C. above the softening point of the adhesive. For example, a tape may include at least two adhesive sections each having an activation temperature range selected from the following: an activation temperature range of 60 to 71° C., an activation temperature range of 60 to 75° C., an activation temperature range of 75 to 95° C., an activation temperature range of 71 to 106° C., an activation temperature range of 105 to 120° C., an activation temperature range of 95 to 120° C., and an activation temperature range of 65 to 95° C., an activation temperature range of 79 to 110° C., or any range encompassed therein (e.g., 80 to 90° C. is encompassed within the activation temperature range of 75 to 95° C.). In certain embodiments, the tape or string may have a first adhesive section having a first activation temperature range of 60 to 71° C., and a second adhesive section having a second activation temperature range of 75 to 95° C. In other embodiments, the tape or string may have a first adhesive section having a first activation temperature range of 60 to 71° C., and a second adhesive section having a second activation temperature range of 105 to 120° C. In further embodiments, the tape or string may have a first adhesive section having a first activation temperature range of 65 to 95° C., and a second adhesive section having a second activation temperature range of 105 to 120° C. In another embodiment, the tape or string may have a first adhesive section having a first activation temperature range of 60 to 71° C., a second adhesive section having a second activation temperature range of 70 to 115° C., and a third adhesive section having a third activation temperature range of 105 to 120° C.

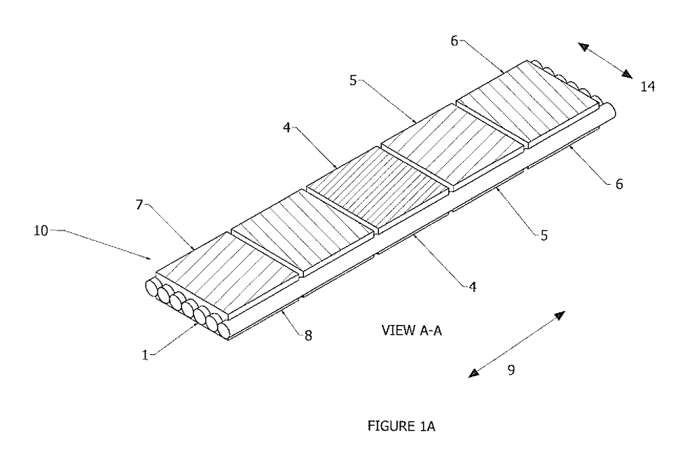

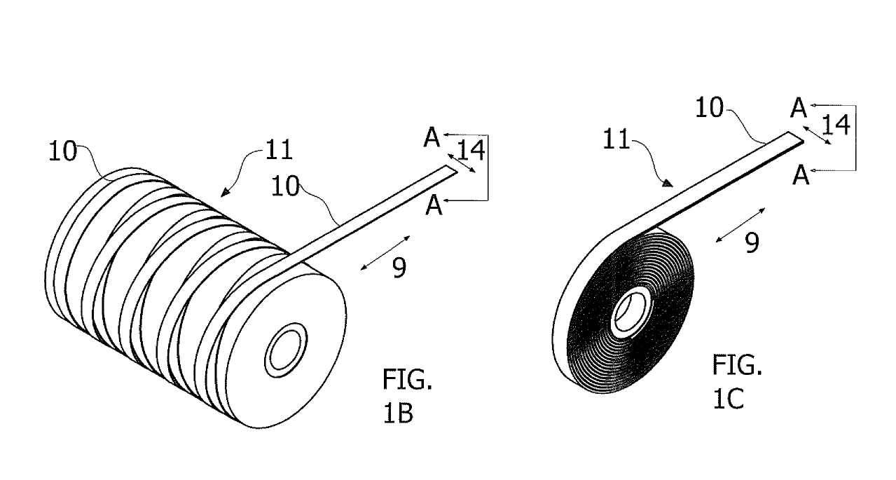

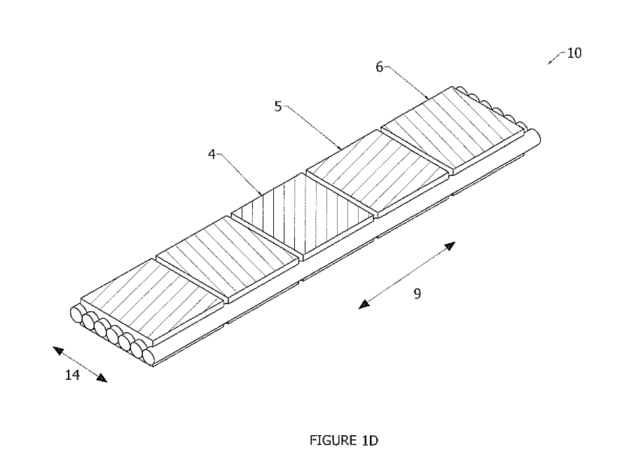

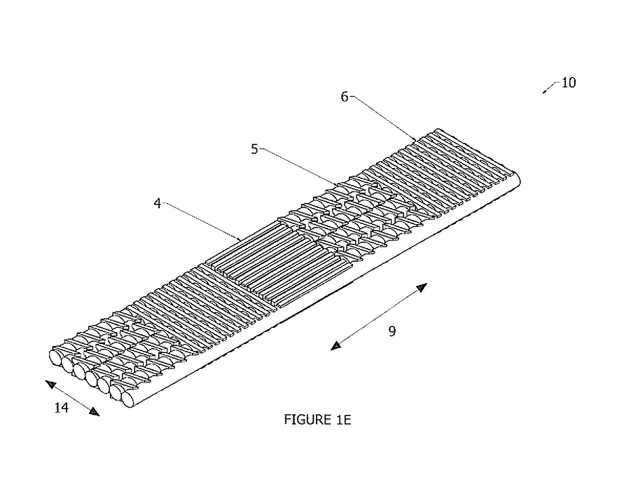

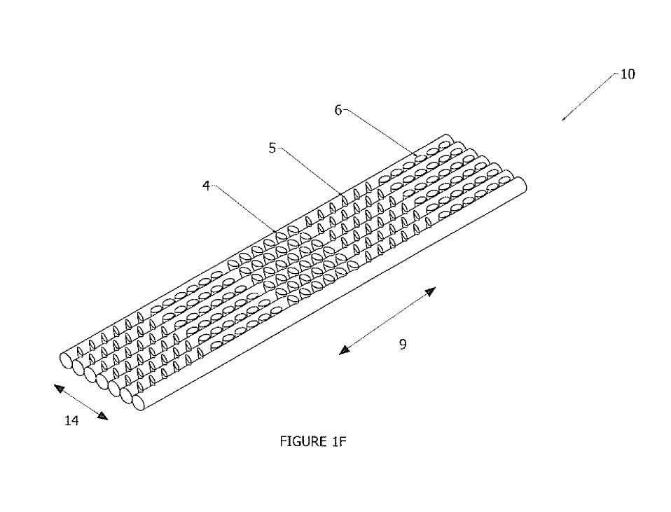

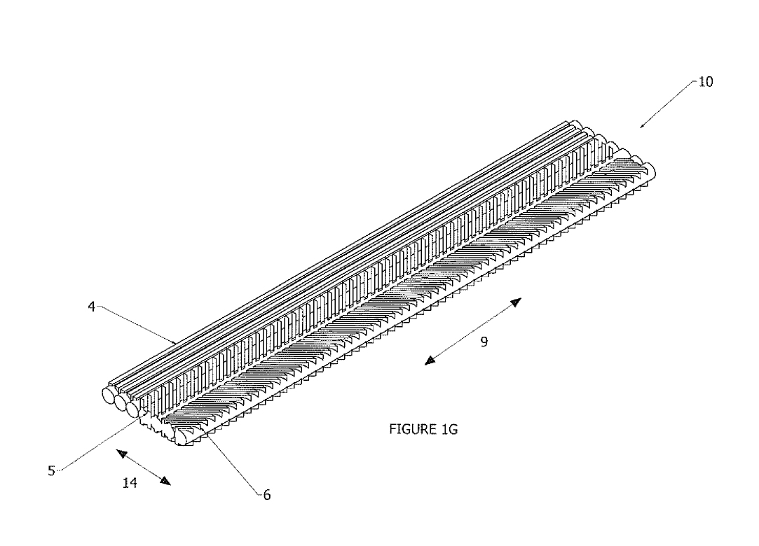

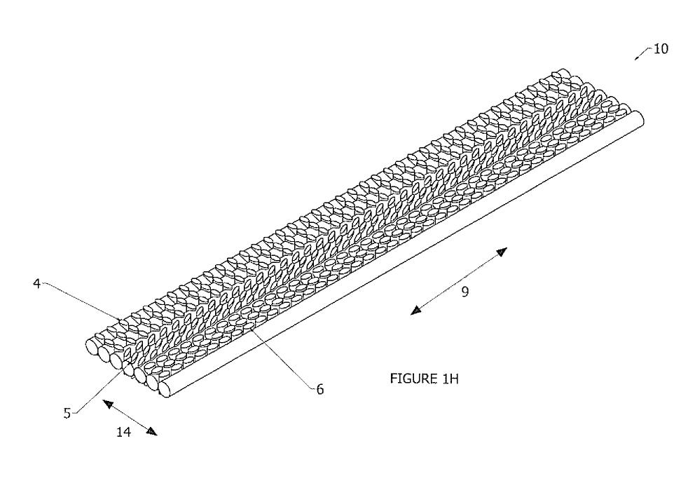

The adhesive sections may be arranged in any manner or pattern to achieve the desired range in properties associated in a single tape. In general, there are a plurality of first adhesive sections and a plurality of second adhesive sections interspersed along the longitudinal direction of the tape or string substrate. In certain embodiments, the sections each individually form a transversely-extending shape. A transversely-extending shape may be any shape that extends from one lengthwise edge of the tape to the other lengthwise edge of the tape. Examples of transversely-extending shapes are shown in FIGS. 1A, 1D, 1E, 1F and 2. The shapes may be in the form of rectilineal (e.g., stripes, quadrilateral, crossbar, polygon), or curvilineal (e.g., oblong, circular, ellipsoidal, ovoid, serpentine) shapes. The shapes may be arranged in a repetitive array (e.g., diamond-shaped array). If the shapes are in the form of stripes or similar rectilineal shapes, the rectilineal shape may be arranged at a 90° angle relative to the longitudinal axis of the tape, or at any angle greater or lesser than 90° relative to the longitudinal axis of the tape. In other embodiments, the sections each individually form a longitudinally-extending shape as shown, for example, in FIGS. 1G, 1H and 1I. In certain embodiments, an adhesive section may consist of a printed pattern of individual spaced-apart lines of adhesive as shown, for example, in FIG. 1A.

Adjacent adhesive sections may or may not contact each other. In certain embodiments, there are a plurality of first adhesive sections and a plurality of second adhesive sections arranged in alternating adjacent segments along the longitudinal direction of the tape or string substrate. In certain embodiments, the alternating adjacent segments may form a repeating pattern.

In certain embodiments, the tape includes only the substrate and the adhesive system disposed on the substrate. For example, the tape may consist of three layers: the substrate; a first adhesive system layer contacting a first surface of the substrate; and a second adhesive system contacting an opposing second surface of the substrate. In other embodiments, the tape may consist of two layers: the substrate; an adhesive system layer contacting a first surface of the substrate. In further embodiments, the tape may consist of three layers: a first substrate (e.g., a cellulosic substrate) that defines a first surface and an opposing second surface; a second substrate (e.g., a fibrous substrate) that defines a first surface and an opposing second surface wherein the first surface of the second substrate contacts the second surface of the first substrate, and an adhesive system layer contacting the second surface of the second substrate.

Activation of a hot melt adhesive involves several properties including tack, softening point, and set time. Softening point describes the temperature at which an adhesive starts to turn from solid to liquid. Tack is the temperature or temperature range an adhesive can hold a substrate in place until it sets. Set time is the amount of time from when two substrates are contacted with each other until they are bonded sufficiently. Open time is the amount of time from adhesive application onto a substrate until a point at which it will no longer produce an acceptable bond when contacted with another substrate.

The flow of adhesives around a substrate and the grab exhibited by the adhesive upon removal from the surface is typically called tack if the adhesive is in its “open” or non-crystallized state. Tack can be exhibited by a packaging adhesive while molten clear down to the solid state. This can be considered the tack range and will be larger or smaller based on whether the adhesive formulation is more crystalline or more amorphous. Tack range takes into account the minimum temperature below which sufficient wetting of substrates do not occur as well as the maximum temperature that will allow for continued contact with the substrate.

In certain embodiments, the first adhesive section has a first tack of 68 to 80° C. and the second adhesive section has a second tack of 75 to 95° C. In certain embodiment, the first adhesive section has a first softening point of 80 to 95° C., and the second adhesive section has a second softening point of 93 to 121° C.

In some embodiments, the tape can have a compression tack of at least 150 gf, more particularly at least 180 gf, and most particularly at least 200 gf.

In certain embodiments, the adhesive is sufficiently heat resistant such that the adhesive, after the tape or string has been applied to the paper board substrate, will maintain sufficient bond strength from −17° C. up to 60° C. This property is important to insure the reinforcement properties contributed by the tape or string are maintained throughout the shipping process, and storage temperature range at typical warehouse conditions.

The hot melt adhesive compositions exhibit improved wide range temperature flexibility and adhesive properties while retaining good processing properties, good set times (e.g., 1 to 3 seconds, 3 to 7 seconds, and 7 or more seconds). Hot melt adhesives are adhesives that are applied at an elevated temperature and achieve a final state and resultant strength by cooling, as contrasted with other adhesives which are applied at room temperature and achieve the final state through evaporation of water or solvents.

There is a wide variety of ingredients that go into making a hot melt adhesive. The formulator has a wide selection of polymers and usually low-molecular weight, natural and synthetic waxes; and tackifying resins to choose from.

Useful tackifying resins include natural and modified rosins such as gum rosin, wood rosin, tall oil rosin, distilled rosin, hydrogenated rosin, dimerized rosin and polymerized rosin; rosin esters such as glycerol and pentaerythritol esters of natural and modified rosins including, e.g., glycerol esters of pale, wood rosin, glycerol esters of hydrogenated rosin, glycerol esters of polymerized rosin, pentaerythritol esters of hydrogenated rosin and phenolic-modified pentaerythritol esters of rosin; phenolic modified terpene or alpha methyl styrene resins and hydrogenated derivatives thereof; aliphatic petroleum hydrocarbon resins; aromatic petroleum hydrocarbon resins, and mixed aromatic and aliphatic hydrocarbon resins and the hydrogenated derivatives thereof; aromatic or phenol modified alicyclic petroleum hydrocarbon resins and the hydrogenated derivatives thereof; alicyclic petroleum hydrocarbon resins and the hydrogenated derivatives thereof; styrenated terpenes; phenol-formaldehyde tackifying resins and combinations thereof.

Useful waxes include paraffin waxes, Fischer-Tropsch waxes, by-product polyethylene waxes, high-density low molecular weight polyethylene waxes, propylene based waxes, microcrystalline waxes, and vegetable waxes.

In order to be converted to more useful adhesives, higher molecular weight polymers are blended therewith. Higher molecular weight polymers, which are typically blended with the natural and synthetic waxes and resins to toughen or reinforce the same, include polyamides, ethylene homopolymers, copolymers and terpolymers (e.g. copolymers of ethylene and vinyl acetate and metallocene catalyzed ethylene copolymers), polyester block polymers, styrene block copolymers (e.g. styrene-butadiene-styrene, styrene-isoprene-styrene or styrene-polyolefin-styrene), polypropylene based homopolymers, copolymers and terpolymers (e.g. atatic amorphous polypropylene and metallocene catalyzed polypropylene based homopolymers and copolymers), ethyl cellulose, acrylates and methacrylates, and polystyrene, etc, and combinations thereof.

While hot-melts are usually a blended mixture of various polymers, it should be understood that any one of the above-mentioned ingredients may be used singly or in combination depending upon the properties desired. In addition, the hot melt adhesives may contain plasticizers, pigments, dyes, UV and thermal stabilizers, fillers and antioxidants.

In certain embodiments, the adhesive compositions may include 20-50 wt. % ethylene copolymer (based on the total dry weight percentage of the adhesive composition), and a tackifying resin component selected from a group consisting of a hydrocarbon tackifying resin, a rosin ester tackifying resin and a mixture thereof. In certain embodiments, the adhesive compositions include 20-60 wt. % hydrocarbon tackifying resin/rosin ester tackifying resin, and 20-40 wt. % terpene phenolic tackifying resin or an equivalent, based on the total dry weight percentage of the adhesive composition. The compositions may also optionally include 5-40 wt. % of a wax compatible with the ethylene copolymer and 0.1-2 wt. % of a stabilizing additive.

Representative ethylene copolymers include ethylene-vinyl ester copolymers wherein the vinyl ester comonomer is typically a C₂-C₆ ester, for example, vinyl acetate, methylacrylate, methyl-methacrylate, ethylacrylate, 2-ethylhexyl acrylate, butylacrylate or acrylic acid. Typically the ester content will be about 18 to 40 wt. %, preferably about 25-35 wt. %. The melt index (“MFI”) (gram flow/10 min., ASTM D 1238-82 Cond. E) will typically range between 2 and 2500, more typically 6 to 500, preferably 6-400. The ethylene-vinyl ester copolymer can be either of the high or low alkyl-branch containing copolymers conventionally known in the art. Useful commercially available ethylene-vinyl ester copolymers include ESCORENE® UL 7760 (MFI=5.7, vinylacetate 26.7 wt. %) from Exxon Chemical Company, ATEVA 2810A from AT Plastics, and ELVAX 260 from DuPont. The ethylene copolymer component makes up a principal part of the adhesive composition. Typically that amount will be greater than about 20 wt. %, based on the total blend weight, preferably greater than about 25 wt. %, and most preferably greater than about 40 wt. %. The amount is typically less than about 50 wt. %, preferably 45 wt. %, or lower. Thus an amount between 30 and 45 wt. % will be particularly useful.

The hydrocarbon tackifying resins and terpene phenolic tackifying resin include any of those that are compatible with the EVA. Rosin esters tackifying resins may also be used. For example the C₅/C₉ resins, any of the C₄, C₅ and/or C₆, and/or terpene, containing resins that also contain a significant portion of C₈, C₉ and/or C₁₀ monomers, e.g., styrene or alkyl-substituted styrene monomers will be suitable. Such are available commercially as nonhydrogenated or hydrogenated hydrocarbon resins prepared by Friedel-Crafts polymerization and if hydrogenated, by conventional metal-catalyzed hydrogenation. Monomers can be provided as pure monomer streams, or pure monomer in solvent, or steam-distilled petroleum fractions, for example, heart cut distillate. Preferred tackifying resins are the aromatic modified aliphatic C₅/C₉, aromatic modified terpene resins or aromatic aliphatic modified terpene resins prepared with or from steam-cracked petroleum fractions and having number-average molecular weights (Mₙ) less than or equal to 900, viscosity-average molecular weights (M_{z}) less than or equal to 3000, a molecular weight distribution (MWD) less than or equal to 2.1, and an aromaticty of 10-40 wt. % aromatic monomers based on total resin number average molecular weight preferably 15-35 wt. %. Resins of similar monomers meeting these physical parameters will be also be particularly suitable. Commercially available resins that are suitable include the SYLVALITE resins of Arizona Chemical Company, particularly the rosin ester resins RE 100F resin products as well as the WESTREZ resins of MeadWestVaco, particularly the 5000 resin products. The most suitable resins have a softening point (Ring & Ball) of 50-120° C., preferably 70-105° C., and most preferably 80-105° C. Below about 50° C. softening point the resins can cause undesirable loss of heat resistance for the adhesive compositions of the invention. The hot melt adhesive compositions of the invention preferably will contain from 30-60 wt. % more preferably 35-45 wt. % tackifying resin. In certain embodiments, the hydrocarbon resin is an aliphatic-aromatic resin having from 10 to 40 wt. %, of total resin number-average molecular weight, of aromatic monomer as measured by NMR.

The compositions may also include antioxidants. The antioxidants, if used, are generally present in amounts of about 0.1 to 1.5 weight percent, preferably 0.25 to 1.0 weight percent. Such antioxidants are commercially available from Ciba-Geigy, Hawthorne, N.Y. and include Irganox® 565, 1010 and 1076 which are hindered phenols. These are primary antioxidants which act as radical scavengers and may be used alone or in combination with other antioxidants such as phosphite antioxidants like Irgafos® 168 available from Ciba-Geigy. Phosphite catalysts are considered secondary catalysts and are not generally used alone. These are primarily used as peroxide decomposers. Other available catalysts are Cyanox® LTDP available from Cytec Industries in Stamford, Conn., and Ethanox® 1330 available from Albemarle Corp. in Baton Rouge, La. Many such antioxidants are available either to be used alone or in combination with other such antioxidants. These compounds are added to the hot melts in small amounts and have no effect on other physical properties. Other compounds that could be added that also do not affect physical properties are pigments which add color, or fluorescing agents, to mention only a couple. Additives like these are known to those skilled in the art. The performance of the antioxidants] may be further enhanced by utilizing, in conjunction therewith, known synergists such as, for example, thiodipropionate esters and phosphites. Distearylthiodipropionate is particularly useful.

Depending on the contemplated end uses of the adhesives, other additives such as plasticizers, pigments, dyestuffs and fillers conventionally added to hot melt adhesives may be included. In addition, small amounts of additional tackifiers and/or waxes such as microcrystalline waxes, hydrogenated castor oil and vinyl acetate modified synthetic waxes may also be incorporated in minor amounts, i.e., up to about 10% by weight, into the formulations of the present invention.

Flow of the adhesive to mate with the substrate is important to adhesion. The selection of the proper tackifying resin(s) and its amount is therefore a factor in adhesive performance. The selection of the tackifying resin type may also dictate the color and odor characteristics of the resulting adhesive. If a fast setting adhesive is desired at least one wax is also typically used to control set speed and heat resistance. The role of the wax(es) is to increase the crystallinity and modulus of the adhesive blend. Fast set and high heat resistance are typically achieved by the most crystalline waxes with the highest melting point (synthetic waxes). Such waxes, however, may prove undesirable in other areas, however, such as adhesion and cold temperature flexibility. For this reason a variety of synthetic, microcrystalline and paraffin waxes are used for various applications.

Lower heat resistance/slower set may be achieved with lower melt point resins and less crystalline waxes. Although wax primarily will drive the set time of the adhesive, lower or higher melt point resins can modify the crystallinity of an adhesive composition and therefore also adjust set time up or down.

Other heat-activatable adhesives that could be used include solvent-based adhesives such as, for example, SC-1755 and SC-1774 (polyester-vinyl chloride-vinyl acetate-based) commercially available from HB Fuller Company (St. Paul, Minn.).

In certain embodiments, the first adhesive section is produced from a first adhesive composition having a viscosity of 6,000 cPs at 176° C. to 18,000 cPs at ° 176° C. and the second adhesive section is produced from an adhesive composition having a viscosity of 8,000 cPs at 176° C. to 22,000 cPs at 176° C.

The tape or string may be applied to any type of paper board substrate. In certain embodiment, the substrate may be a corrugated paper board. The corrugated board substrate includes an exterior liner and a corrugated member. In some implementations, the corrugated member consists of a series of parallel flutes. However, in other implementations, the corrugated member can include other configurations, such as a waffle-type pattern or honeycomb. The corrugated paper board may be a single wall structure (i.e., includes a single fluted corrugated medium and at least one liner layer) or a multiwall structure (i.e., includes at least two fluted corrugated mediums and at least one liner layer). One or more substrates can form an article of manufacture such as a packaging container. Examples of packaging containers include cartons and boxes, such as cartons for holding beverages for sale at the retail level (for instance, a hand-carry carton that holds six, 12 or 24 or more bottles or cans of a beverage), meat and produce bulk bins, wet-packed containers, reusable containers, rubber and chemical bulk bins, heavy duty containers, bags, and envelopes. A continuous corrugated board substrate can be manufactured by bonding the corrugated member to the exterior liner, and subjecting the exterior liner and corrugated member to heat.

The tape or string may be used as a tear tape for opening an article, such as a container, made from a paper board substrate. The tape or string may be used in one-tape opening systems or multi-tape opening systems (e.g., a two-tape opening system). Tape opening systems can also provide reinforcement of a container substrate while facilitating effective opening of the container. Multi-tape opening systems typically include at least two tapes—a tear tape and a guide tape. The presently disclosed tape may be utilized as the tear tape with another type of a tape as the guide tape, or both the tear tape and the guide tape may be the presently disclosed tapes.

A first embodiment of a first tape 10 disclosed herein is shown in FIG. 1A. The tape 10 is constructed of fibers 1 that define a first surface 7 and an opposing second surface 8. The tape also has a longitudinal axis 9 and a transverse axis 14. The fibers 1 may be unidirectionally aligned along the longitudinal axis 9. At least two hot melt adhesives of different compositions having different activation temperature ranges are disposed on the first surface 7 and opposing second surface 8 of the fibers 1 in a transversely-extending, longitudinally repeated segmented arrangement along the longitudinal length of the tape. The embodiment shown in FIG. 1A includes a first hot melt adhesive section 4, a second hot melt adhesive section 5, and a third hot melt adhesive section 6. Alternatively, the tape may have only two different adhesive sections. The width of each hot melt adhesive section may be between 2 mm to 25.4 mm wide but preferably between 6.3 mm to 12.7 mm wide. The first hot melt adhesive section 4, the second hot melt adhesive section 5, and the third hot melt adhesive section 6 form an adhesive system that may be a layer that covers all, or only a portion thereof, of the area of the first surface 7 and opposing second surface 8. The hot melt adhesives 4, 5 and 6 may or may not impregnate the fibers 1.

A second embodiment of a tape 30 disclosed herein is shown in FIG. 2. The tape 30 is constructed of a film or web 2 that defines a first surface 7 and an opposing second surface 8. At least two hot melt adhesives of different compositions having different activation temperature ranges are disposed on the first surface 7 and opposing second surface 8 of the film or web substrate 2 in a transversely-extending, longitudinally repeated segmented arrangement along the longitudinal length of the tape. The embodiment shown in FIG. 2 includes a first hot melt adhesive section 4, a second hot melt adhesive section 5, and a third hot melt adhesive section 6. Alternatively, the tape may have only two different adhesive sections. The width of each hot melt adhesive section may be 2 mm to 25.4 mm wide but preferably between 6.3 mm to 12.7 mm wide. The first hot melt adhesive section 4, the second hot melt adhesive section 5, and the third hot melt adhesive section 6 form an adhesive system that may be a layer that covers all, or only a portion thereof, of the area of the first surface 7 and opposing second surface 8.

A third embodiment of the tape 40 disclosed herein is shown in FIG. 3. The tape 10 is constructed of a film 2 that defines a first surface 7 and an opposing second surface 8. At least two hot melt adhesives of different compositions having different activation temperature ranges are disposed on the first surface 7 in a transversely-extending, longitudinally repeated segmented arrangement along the longitudinal length of the tape. The embodiment shown in FIG. 3 includes a first hot melt adhesive section 4, a second hot melt adhesive section 5, and a third hot melt adhesive section 6. Alternatively, the tape may have only two different adhesive sections. The width of each hot melt adhesive section may be 2 mm to 25.4 mm wide but preferably between 6.3 mm to 12.7 mm wide. The first hot melt adhesive section 4, the second hot melt adhesive section 5, and the third hot melt adhesive section 6 form an adhesive system that may be a layer that covers all, or only a portion thereof, of the area of the first surface 7. The hot melt adhesive-coated film surface forms an inner layer of the tape 40 and the opposing surface forms an outer layer of the tape 40.

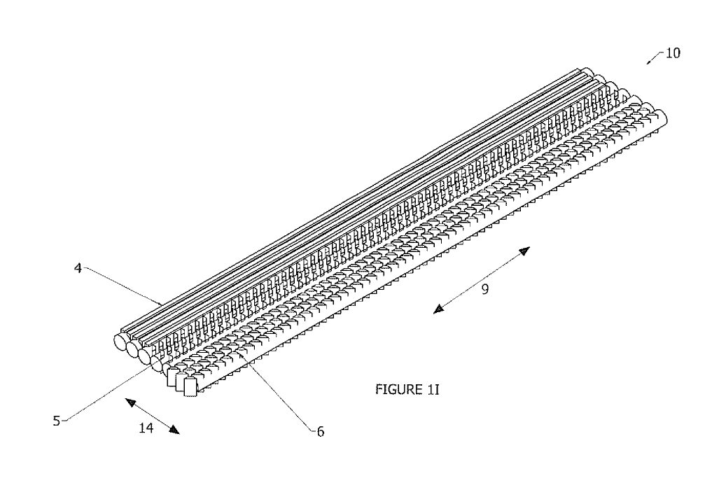

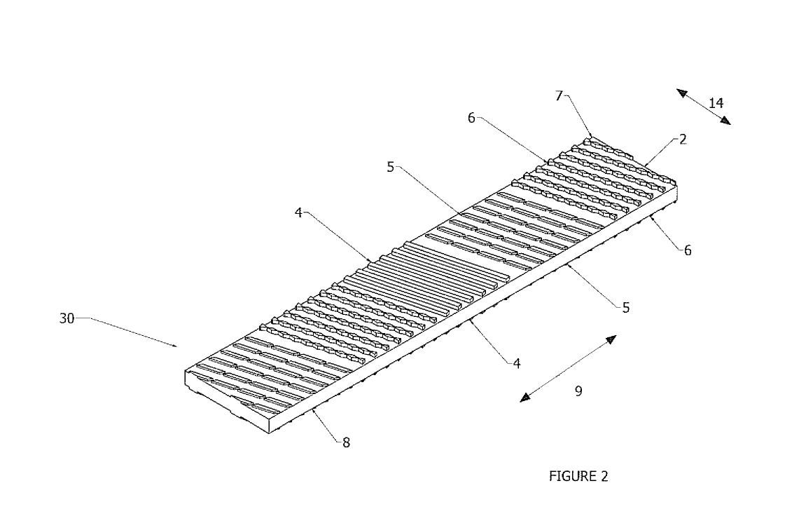

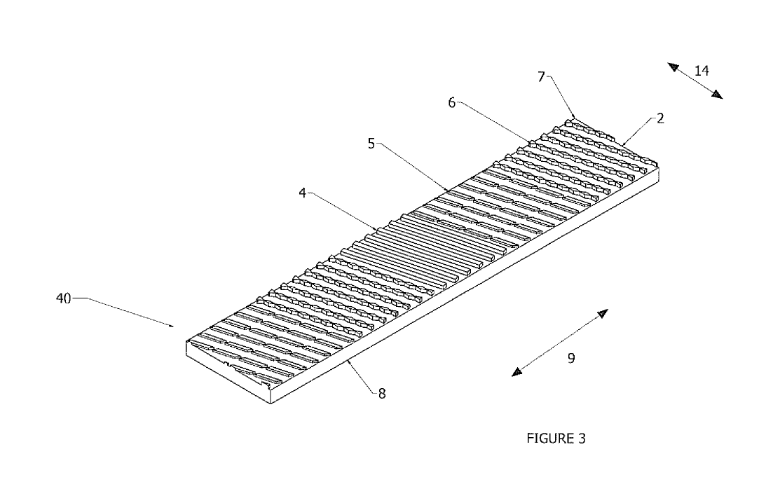

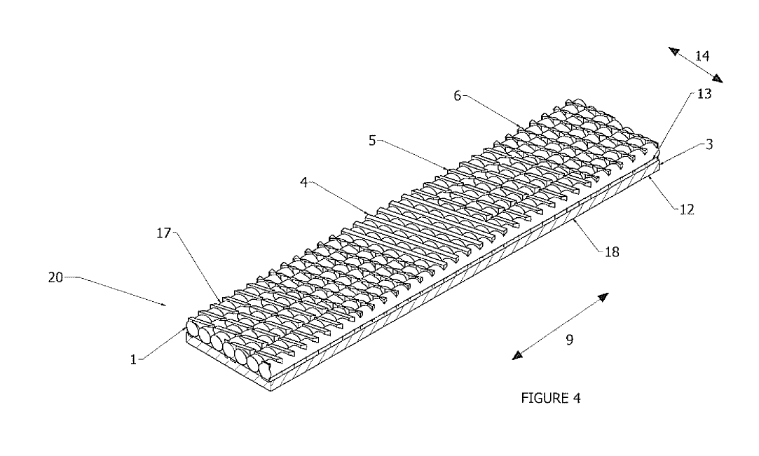

In a fourth embodiment of a tape 20 disclosed herein is shown in FIG. 4. The tape 20 includes a cellulosic substrate 3 that defines a first surface 12 and an opposing second surface 13. Fibers 1 are disposed on the second surface 13 of the cellulosic substrate 3. The fibers 1 may be unidirectionally aligned along the longitudinal axis 9. The fibers 1 are adhered to the second surface 13 of the cellulosic substrate 3. At least two hot melt adhesives of different compositions having different activation temperature ranges are disposed on the fibers 1 in a transversely-extending, longitudinally repeated segmented arrangement along the longitudinal length of the tape. The embodiment shown in FIG. 4 includes a first hot melt adhesive section 4, a second hot melt adhesive section 5, and a third hot melt adhesive section 6. Alternatively, the tape may have only two different adhesive sections. The width of each hot melt adhesive section may be 2 mm to 25.4 mm wide but preferably between 6.3 mm to 12.7 mm wide. The tape 20 defines a first surface 17 and an opposing second surface 18. The first hot melt adhesive section 4, the second hot melt adhesive section 5, and the third hot melt adhesive section 6 form an adhesive system that may be a layer that covers all, or only a portion thereof, of the area of the first surface 17. The hot melt coated fibers form the inner surface 17 of the tape 20 and the opposing surface 18 forms the outer layer of the tape 20. The cellulosic substrate may be a paper substrate. For example, any of the types of papers that can assist in providing the desired tape weft strength can be employed. In certain embodiments the cellulosic substrate also provides a barrier to prevent undesirable wicking of the hot melt adhesive composition from one side of the cellulosic substrate to the opposing side of the cellulosic substrate. Examples of the types of paper which can be used include paper, clay coated paper, glassine, polymer coated paper, paperboard from straw, bark, wood, cotton, flax, cornstalks, sugarcane, bagasse, bamboo, hemp, and similar cellulose materials prepared by such processes as the soda, sulfite or sulfate (Kraft) processes, the neutral sulfide cooking process, alkali-chlorine processes, nitric acid processes, semi-chemical processes, etc. Although paper of any weight can be employed as a substrate material, paper having basis weights ranging from 97 g/m² to 440 g/m² is preferred.

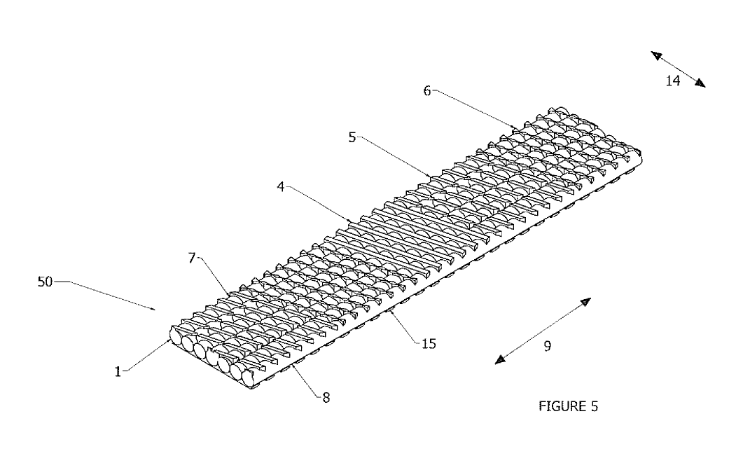

A fifth embodiment of a tape 50 disclosed herein is shown in FIG. 5. The tape 50 is constructed of fibers 1 that define a first surface 7 and an opposing second surface 8. The fibers 1 may be unidirectionally aligned along the longitudinal axis 9. At least two hot melt adhesives of different compositions having different activation temperature ranges are disposed on the first surface 7 in a transversely-extending, longitudinally repeated segmented arrangement along the longitudinal length of the tape. The embodiment shown in FIG. 5 includes a first hot melt adhesive section 4, a second hot melt adhesive section 5, and a third hot melt adhesive section 6. Alternatively, the tape may have only two different adhesive sections. The width of each hot melt adhesive section may be 2 mm to 25.4 mm wide but preferably between 6.3 mm to 12.7 mm wide. The first hot melt adhesive section 4, the second hot melt adhesive section 5, and the third hot melt adhesive section 6 form an adhesive system that may be a layer that covers all, or only a portion thereof, of the area of the first surface 7. The hot melt adhesives 4, 5, and 6 may or may not impregnate the fibers 1. A heat barrier coat 15 is disposed on the second surface 8 of the fibers along the length of the tape. The barrier coat 15 may or may not impregnate the fibers 1. The barrier coat 15 may be a layer that covers all, or a portion thereof, of the area of the second surface 8. The hot melt coated fibers form an inner layer 7 of the tape 50 and the opposing side 8 forms the outer layer of the tape 50.

The tape 50 (or tape 10, 20, 30, 40) may be provided in the form of a roll product 11 as shown, for example, in FIGS. 1B and 1C. In the embodiment shown in FIG. 1B the tape 10 is wound upon itself in an arrangement in which an outer length of tape 10 is aligned at an angle, particularly an acute angle, relative to an inner length of tape 10 upon which the outer length is disposed. In other words, each successive wind of the tape 10 traverses the previous, or underlying, tape 10 wind at an angle, particularly an acute angle. The FIG. 1B embodiment is an example of a “traverse wound roll.” In the embodiment shown in FIG. 1C the tape 10 is would upon itself so that each successive wind of the tape 10 is aligned parallel to the previous, or underlying, tape 10 wind. The FIG. 1C embodiment is an example of a “pancake wound roll.” A single roll product 10 (or successive roll products 10 appropriately fastened to each other) may be introduced into a corrugator system even if the corrugating system processing temperatures and/or line speeds vary.

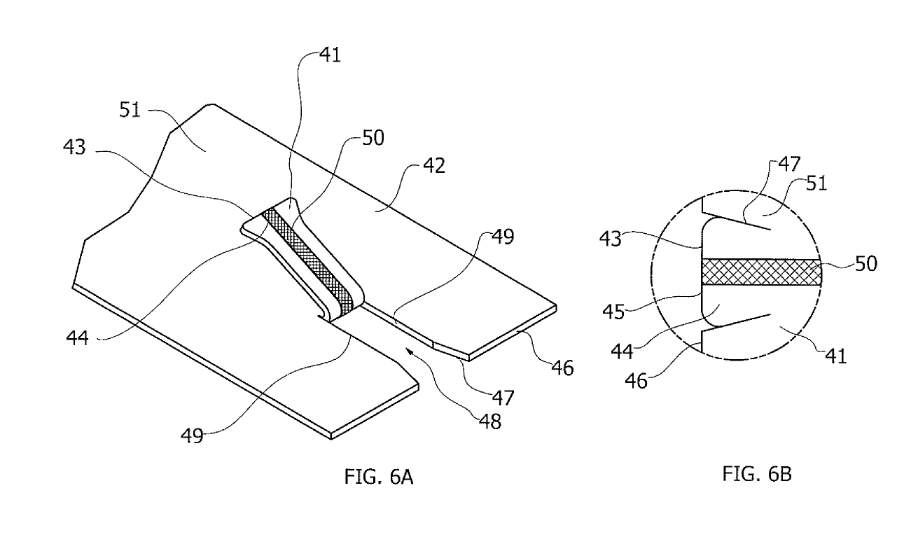

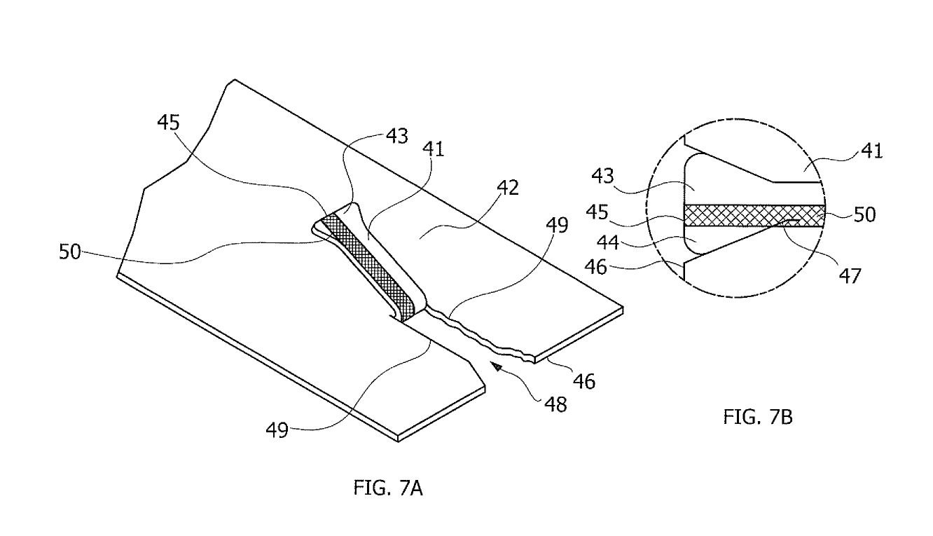

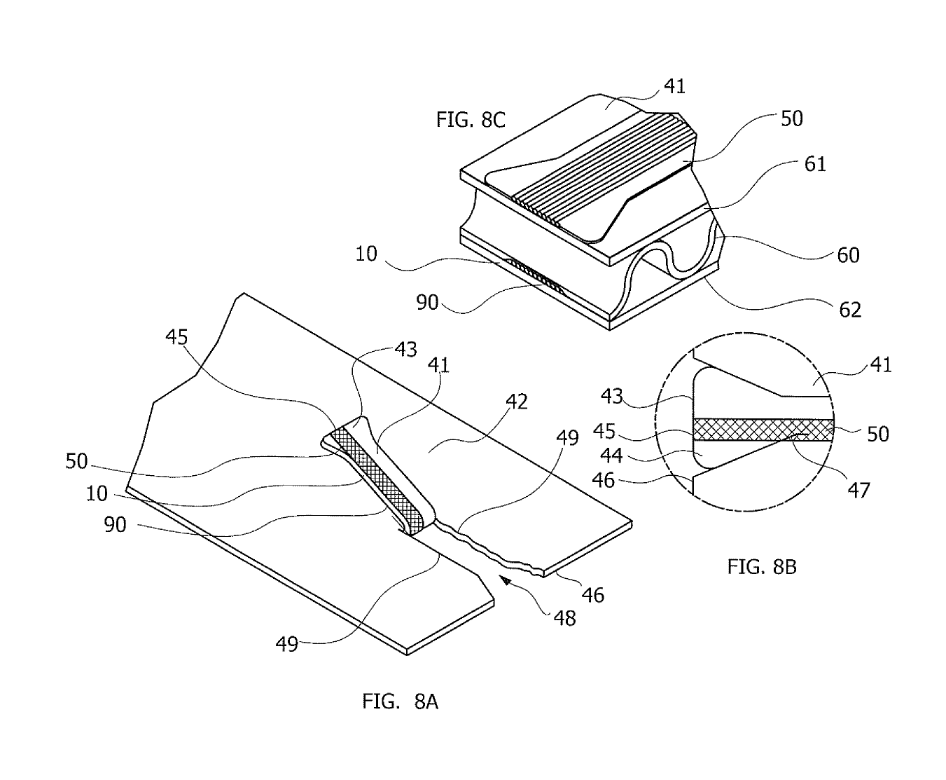

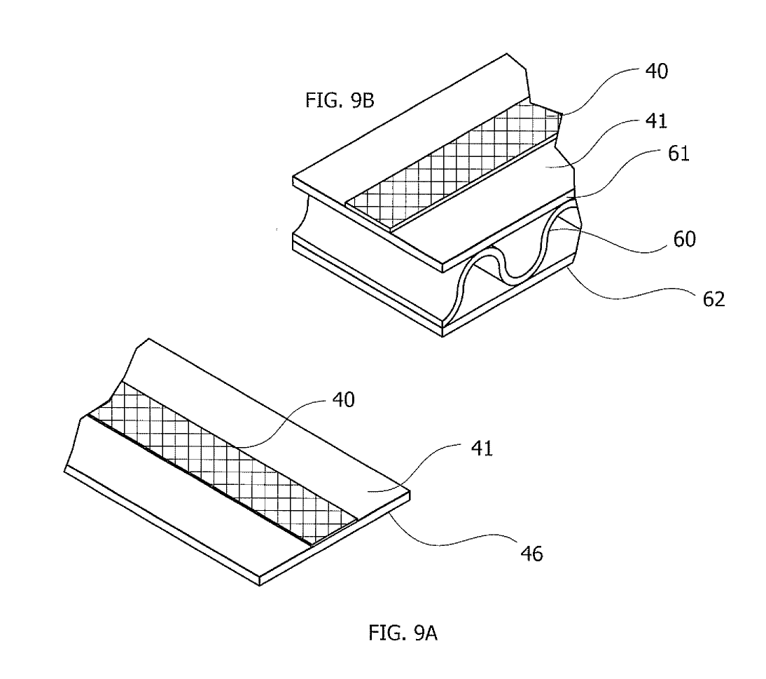

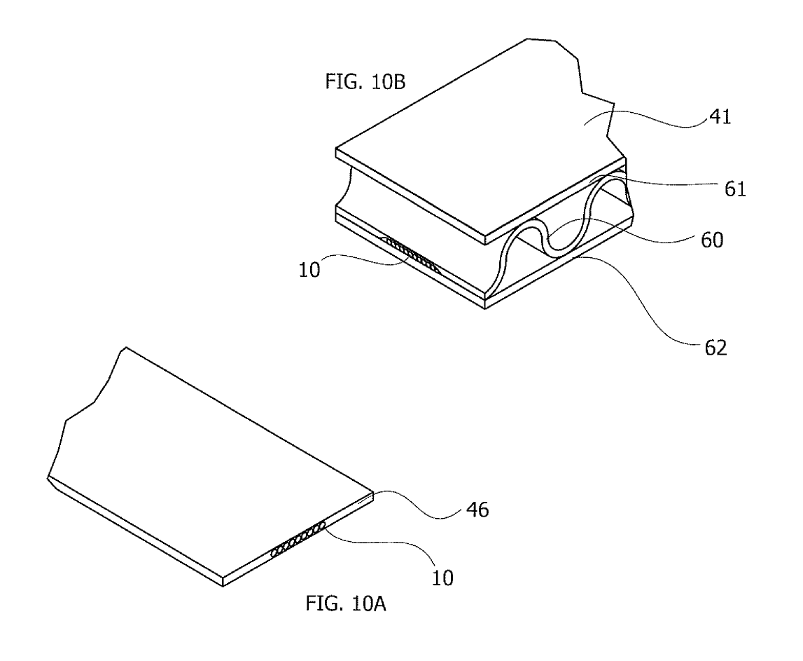

The tape may be applied to any type of paper board substrate. In certain embodiments, the substrate may be a corrugated paper board as shown in FIGS. 8-10 and 13-15. The corrugated board substrate includes an exterior liner 62 and a corrugated member 60. In some implementations, the corrugated member consists of a series of parallel flutes. However, in other implementations, the corrugated member can include other configurations, such as a waffle-type pattern or honeycomb. The corrugated paper board may be a single wall structure (i.e., includes a single fluted corrugated medium and at least one liner layer) or a multiwall structure (i.e., includes at least two fluted corrugated mediums and at least one liner layer). One or more substrates can form an article of manufacture such as a packaging container. Examples of packaging containers include cartons and boxes, such as cartons for holding beverages for sale at the retail level (for instance, a hand carry carton that holds six, 12 or 24 bottles or cans of a beverage), meat and produce bulk bins, wet-packed containers, reusable containers, rubber and chemical bulk bins, heavy duty containers, bags, and envelopes. A continuous corrugated board substrate can be manufactured by bonding the corrugated member to the exterior liner using starch, and subjecting the exterior liner and corrugated member to heat. The tape or string may be used as a tear tape or string for opening an article, such as a container, made from a paper board substrate as shown in FIGS. 6A, 6B, 7A, 7B, 8A, 8B and 16. The tape may be used in one-tape opening systems FIGS. 6A-6B and 7A-7B, or multi-tape opening systems 8A-8C (e.g., a two-tape opening system). Tape opening systems can also provide reinforcement of a container substrate while facilitating effective opening of the container. Multi-tape opening systems FIG. 8A and FIG. 8B typically include at least two tapes—a tear tape and a guide tape 90. The presently disclosed tape may be utilized as the tear tape 20 (or 40, 50) with a tape 10 as the guide tape.

FIGS. 6A and 6B, and FIGS. 7A and 7B, show embodiments of a one-tape tear opening system. The tape 20 (or tape 40, 50) is adhesively secured to a first surface 41 of a paper board substrate 46. The first surface of the tape 20 (or tape 40, 50) on which the adhesive is disposed contacts the first surface 41 of the paper board substrate 46 so that the tape 20 is adhesively secured to the paper board substrate 46. The paper board substrate 46 also includes a second surface 42 opposing the first surface 41. A tear tab 43 is formed in the paper board substrate 46. In certain embodiments the tear tab 43 has a flared handle portion 44 at its tear-initiating end 45 that enables a user to grip and pull the tear tab 43. The tear-initiating end 45 of the tear tab 43 may be located at an edge of the paper board substrate.

In certain embodiments the tear tab 43 may be made by cutting a profile or pattern that extends through the entire thickness of the paper board substrate 46 and that matches the profile or pattern of the tear tab 43. The cut 47 for the tear tab 43 is made during the converting of the paper board substrate into a container so that the cut 47 and associated tear tab 43 are present in the finished container made from the paper board substrate. In the embodiment shown in FIGS. 6A and 6B, the cut 47 does not cut into the tape 20. In the embodiment shown in FIGS. 7A, 7B, 8A and 8B the cut 47 also extends into a portion of the tape 20.

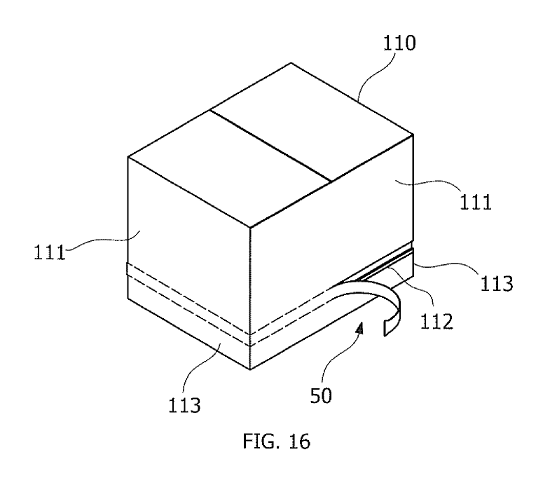

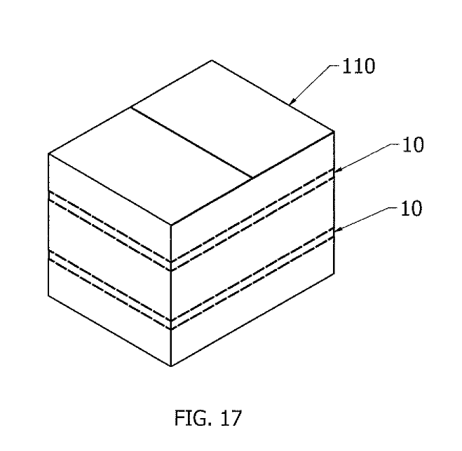

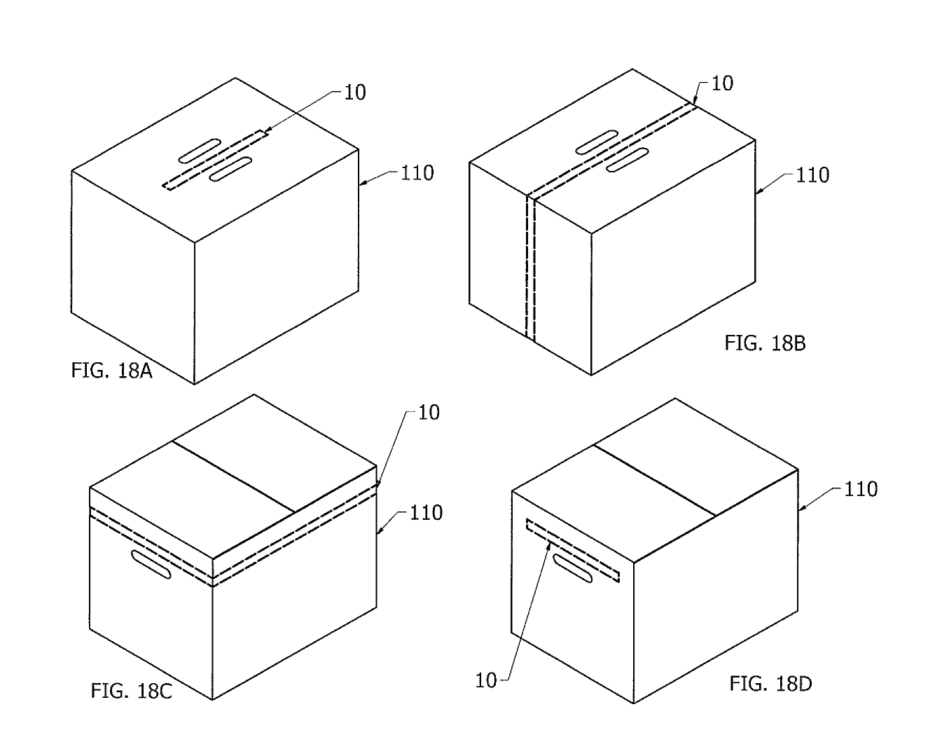

The paper board substrate 46 with the tape 20 (or tape 40, 50) may be formed into a container. The first surface 41 of the paper board substrate 46 that carries the tape 20 forms the interior surface of the container, and the opposing second surface 42 of the paper board substrate 46 forms the exterior surface of the container. Because of the cut 47 extending through the entire thickness of the paper board substrate 46, a user can grip the tear tab 43 and pull on the tear tab 43 to open the container along desired tear lines 49. For example, FIGS. 6A, 7A, and 8A show a tear opening 48 forming in the paper board substrate 46. The tear opening 48 can be extended a desired distance to open the container. For example, the tear tape 20 may be horizontally disposed around the peripheral circumference of a container FIG. 16 thereby dividing the container into an upper section 111 and a lower section 113.

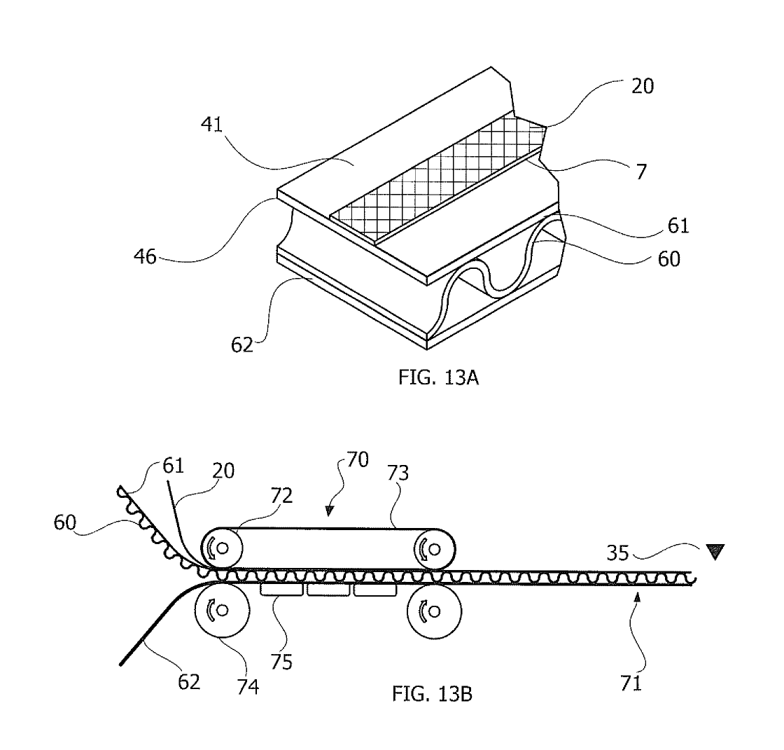

FIG. 13A shows an embodiment in which tape 20 (or tape 40, 50) is disposed on the first surface 41 of a paper board substrate 46. An adhesive side of tape 20 is adhesively secured to the first surface 41 of the paper board substrate 46. In this embodiment the paper board substrate 46 is a corrugated board substrate that includes a fluted or corrugated inner medium 60 disposed between inner liner 61 and outer liner 62.

A continuous corrugated board substrate that includes tape 20 may be made, for example, by the process shown in FIG. 13B. FIG. 13B shows a corrugator having a hot plate and pressure segment 70, a cooling segment 71, and cut-off 35. The cut-off 35 may be a knife that cuts the corrugated board substrate into its desired length. Inside liner 61 adhered to the flutes of one side of the corrugated medium 60 is fed between pressure rolls 72 driving a pressure belt 73. In the hot plate and pressure segment 70 of the corrugator, tape 20 (or 40 or 50) is applied to the outside surface of the inner liner 61. An outside liner 62 is applied to the opposing flutes of corrugated medium 60 by being fed into the nip of roller 74. Thus, the tape 20, outside liner 62, corrugated medium 60, and inside liner 61 are sandwiched between pressure belt 73 and hot plates 75. Upstream from the rollers 72 and 74, the appropriate tape adhesive section 4, 5, and/or 6, etc. on the tape 20 (and the adhesive applied to the flutes of the corrugated medium 60) is heat activated so that when the four elements pass between pressure belt 73 and hot plates 75, the outside liner is firmly adhered to the corrugated member 60 and the tape 20 is firmly secure to the inner liner 61. Activation of the adhesives on the tape takes place in the hot plate and pressure segment 70 at the corrugator processing temperature range. Setting of the adhesive takes place in the cooling segment 71 and prior to the cut off 31. In certain embodiments, the adhesive set time is equal to or less than the amount of time it takes for a given point on the tape 20 to move from the end of the hot plate/pressure segment 70 to the cut-off 35. In other words, the adhesive set time is equal to or less than the amount of time it takes for a given point on the tape 20 to travel from the exit of the hot plate and pressure segment 70 and prior to the cut off 35(referred to herein as the corrugated board “dwell time”). For example, if the cooling segment of the corrugator is 50 meters long and the paperboard substrate is traveling at 300 meters per minute the dwell time calculates to be 10 seconds or 0.167 minutes. For the tape disclosed herein the set time of one of the adhesive sections needs to be less than the dwell time of the corrugators for the tape to firmly adhere to the paperboard substrate.

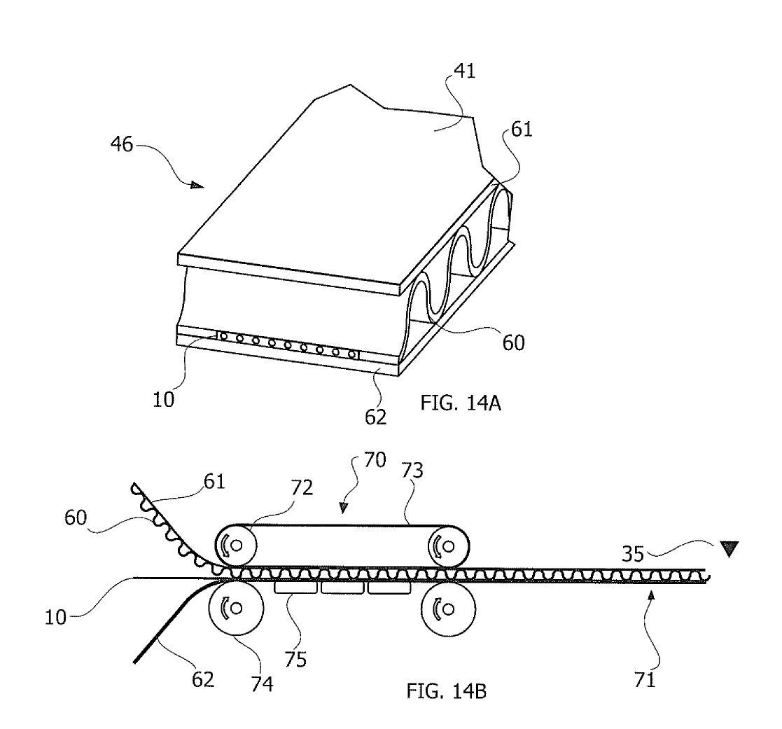

FIG. 14A shows an embodiment in which tape 10 (or tape 30) is disposed within the paper board substrate 46. In this embodiment the paper board substrate is a corrugated board substrate that includes a fluted or corrugated inner medium 60 disposed between inner liner 61 and outer liner 62. The tape 10 may be located between the outer liner 62 and the corrugated medium 60, or the tape 10 may be located between the inner liner 61 and the corrugated medium 60. As described above, the paper board substrate 46 and tape 10 may be formed into a container. The first surface 41 of the paper board substrate forms the interior surface of the container, and the opposing second surface 42 of the paper board substrate 46 forms the exterior surface of the container.

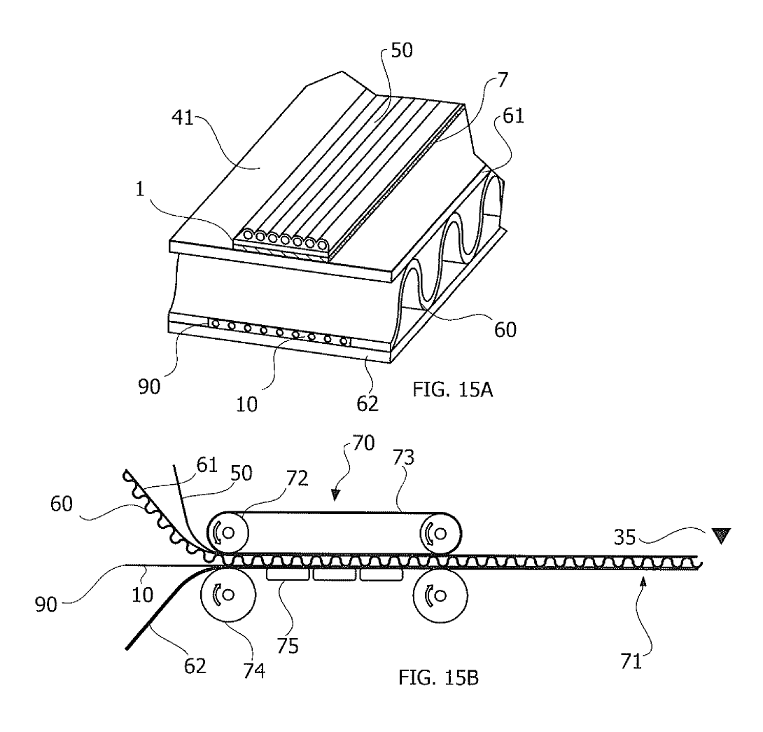

FIG. 15A shows an embodiment of a two-tape tear opening system in which one of the tapes is the tape 50 disclosed herein and the guide tape 90 is the second tape 10 disclosed herein. More specifically, tape 50 is disposed on the first surface 41 of a paper board substrate 46. The appropriate adhesive section 4, 5 and/or 6, etc. of tape 50 is adhesively secured to the first surface 41 of the paper board substrate 46. In this embodiment the paper board substrate is a corrugated board substrate that includes a fluted or corrugated inner medium 60 disposed between inner liner 61 and outer liner 62. A second tape 10, which is a guide tape 90, is disposed within the paper board substrate 46. The second tape 10 may be located between the outer liner 62 and the corrugated medium 60, or the second tape 10 may be located between the inner liner 61 and the corrugated medium 60. As described above, the paper board substrate 46 with the tear tape 50 and second tape 10 may be formed into a container. The first surface 41 of the paper board substrate 46 that carries the tape 50 forms the interior surface of the container, and the opposing second surface 42 of the paper board substrate 46 forms the exterior surface of the container. The second tapes 10 or 50 is heat-activatable and set by the corrugating process as described above. The second tape 10 is aligned parallel to the tear tape 50 and underlies (i.e., is juxtaposed with) the tape 50. The tapes 10 and 50 can be sized to have the same or different widths. In certain embodiments, the second tape 10 is wider compared to tape 50. The second tape 10 is a guide tape that has minimal weft or cross machine direction strength. This lack of weft strength in guide tape 10 together with strength in the machine direction allows tearing of the guide tape along the tear lines while simultaneously maintaining edge reinforcing there along. Thus, by grasping tear tab 43 formed by tear tab cut 47 and pulling the same in the longitudinal direction of tear tape 50 and guide tape 10, tear tape 50 tears through the material of paper board substrate 46 substantially coincident with tear tape 50 and also tears along guide tape 10 which guides the tear and provides edge reinforcing resulting in substantially even tear lines 49.

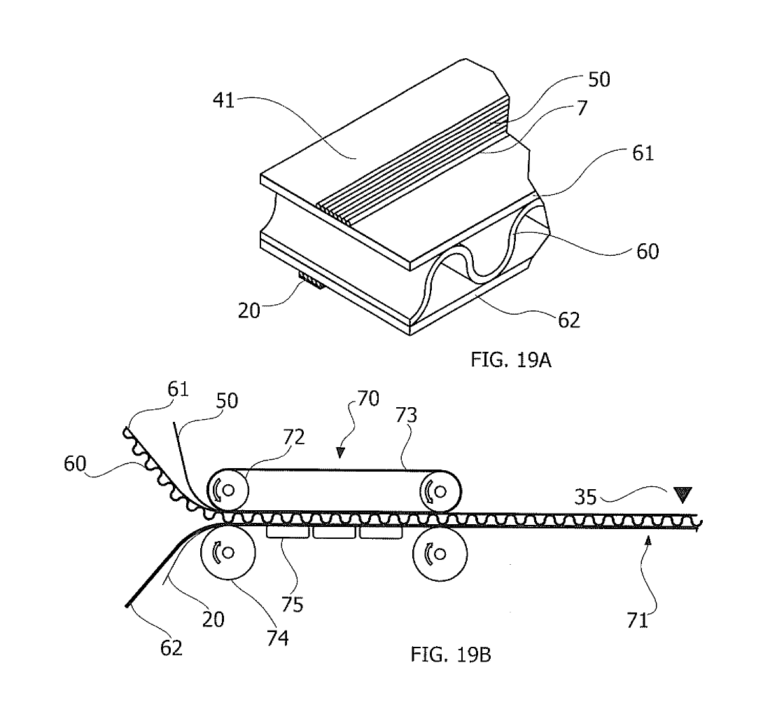

In another embodiment FIG. 19A, the guide tape 90 may be tear tape 20 located on the second surface 42 of the paper board substrate 46 rather than embedded within the paper board substrate. Thus, when the paper board substrate is formed into a container, the guide tape 90 is disposed on the exterior surface of the container. Guide tape 90 is applied to the outside surface of outside liner 62 by feeding it into the nip of the pressure roll 72 and roller 74 between outside liner 26 and corrugated medium 60 (see FIG. 19B).

FIG. 19A shows an embodiment of a two-tape tear opening system in which both of the tapes are the tapes disclosed herein. More specifically, a first tape 50 is disposed on the first surface 41 of a paper board substrate 46. An appropriate adhesive section 4, 5, and/or 6, etc. of tape 50 is adhesively secured to the first surface 41 of the paper board substrate 46. A second tape 20 or 50 is disposed on the second surface 42 of the paper board substrate 46. An appropriate adhesive section 4, 5, and/or 6, etc. of tape 20 or 50 is adhesively secured to the second surface 42 of the paper board substrate 46. In this embodiment the paper board substrate is a corrugated board substrate that includes a fluted or corrugated inner medium 60 disposed between inner liner 61 and outer liner 62. The second tape 20 or 50 serves as a guide tape as described above in connection with tape 90. FIG. 19B depicts a method of applying both tapes 50 and 20 onto the paper board substrate via pressure rollers 76.

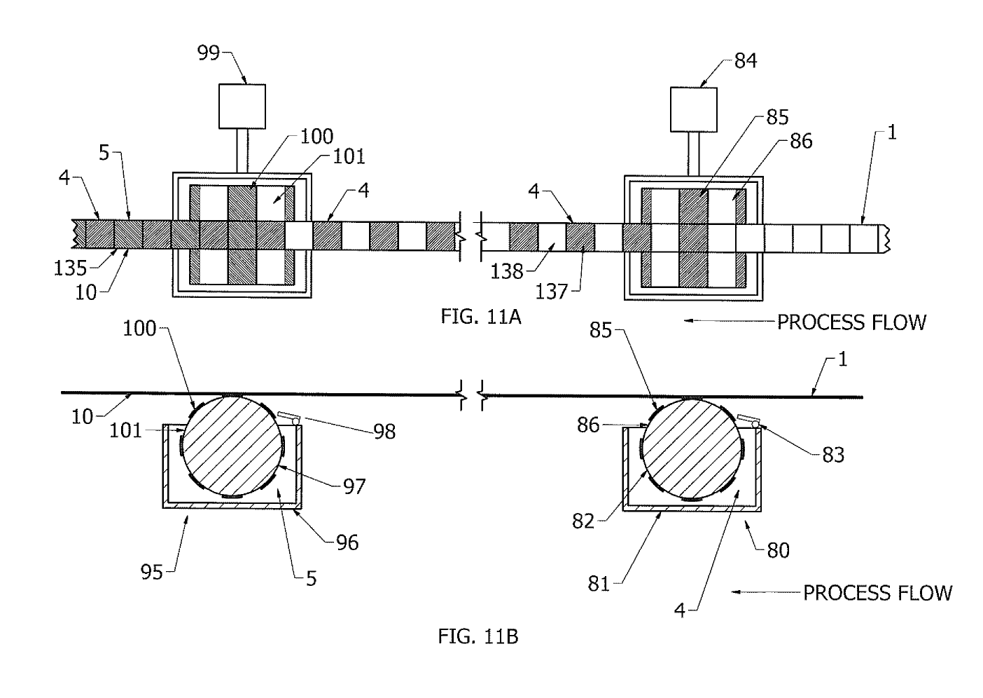

Processes for making the adhesive tapes are described below. FIGS. 11A and 11B show an embodiment in which the tape substrate (e.g., fibrous tape 1, film tape 2, or cellulosic substrate 3) has a first adhesive 4 and a second adhesive 5 applied to create the print in FIG. 1D. A first adhesive coater 80 is comprised of a first adhesive pot 81 to hold the first adhesive 4, first print roll 82 to transfer the first adhesive 4 to the tape substrate, first doctor blade 83 to meter the adhesive volume applied to the first print roll 81, and first print roll drive means 84 to turn the print roll at a linear speed equal to or nearly equal to the linear speed of the tape substrate. The first print roll 82 has a repeating print pattern area 85 and non-print pattern area 86 around the circumference of the first print roll 82.

A second adhesive coater 95 is comprised of a second adhesive pot 96 to hold the second adhesive 5, second print roll 97 to transfer the second adhesive 5 to the tape substrate, second doctor blade 98 to meter the adhesive volume applied to the second print roll 97, and second print roll drive means 99 to turn the print roll at a linear speed equal to or nearly equal to the linear speed of the tape substrate. The second print roll 97 has a repeating print pattern area 100 and non-print pattern area 101 around the circumference of the second print roll 97.

The print area 85 on the first print roll 82 is equal to or nearly equal to in spacing to the print area 100 on the second print roll 97. The non-print area 86 on the first print roll 82 is equal to or nearly equal to in spacing to the non-print area 101 on the second print roll 97.

A continuous tape 10 (or 20, 30, 40, 50) may be made by the process shown in FIGS. 11A and 11B. FIGS. 11A and 11B show the tape substrate being pulled over the first print roll 82 as the print roll rotates at the same linear speed as the tape substrate thereby transferring adhesive from the first print roll print area 85 to the tape substrate and not transferring adhesive from the first print roll non print area 86 to the tape substrate. The tape substrate coated with the first adhesive pattern are then pulled over the second print roll 97 as the print roll rotates at the same linear speed as the tape substrate thereby transferring adhesive from the second print roll print area 100 to the tape substrate and not transferring adhesive from the second print roll non print area 101 to the tape substrate. The first print roll drive means 84 and second print roll drive means 99 collaborate in coating the tape substrate with first adhesive 4 and second adhesive 5 such that the adhesives are coated adjacent or near adjacent to each other in creating the print in FIG. 1D.

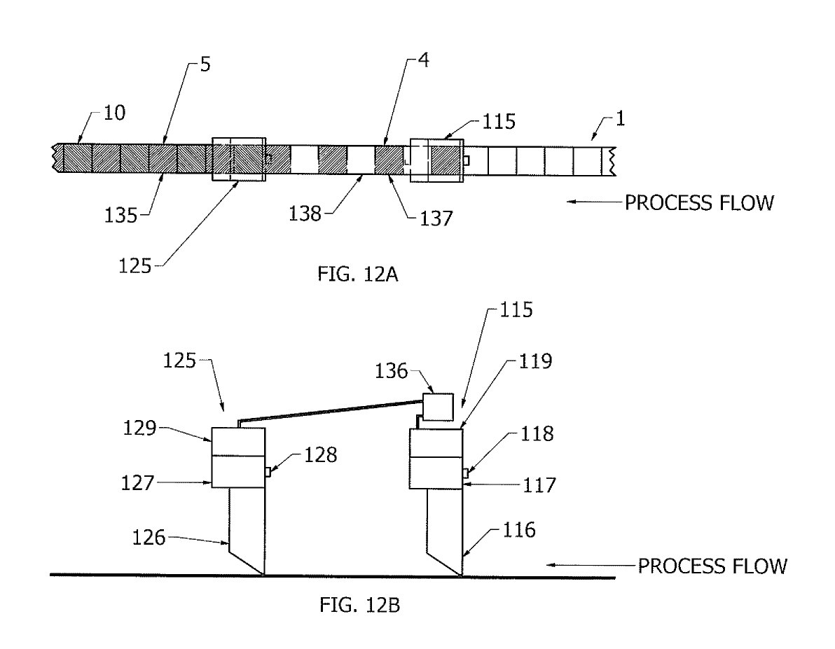

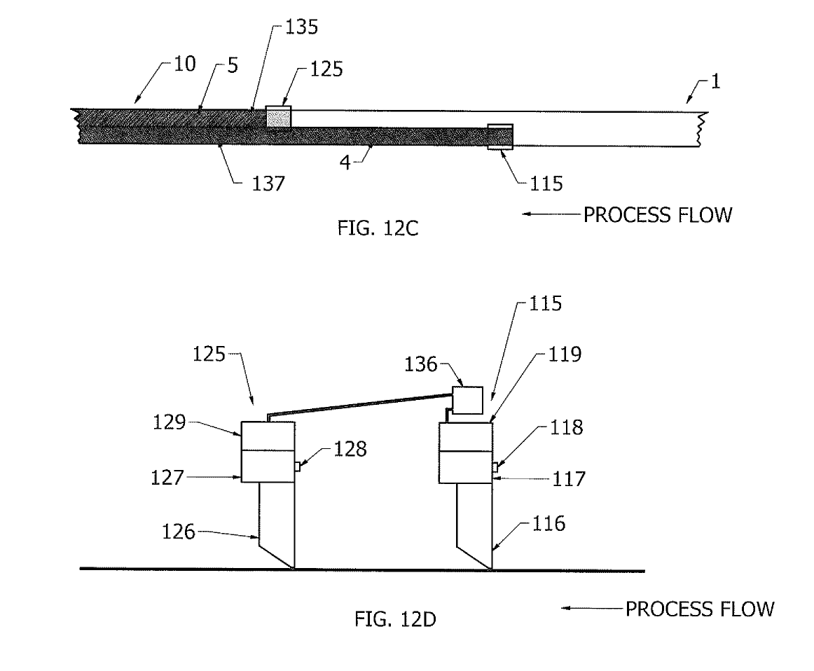

FIGS. 12A and 12B show an embodiment in which the tape substrate has a first adhesive 4 and second adhesive 5 applied to create the print in FIG. 1E or FIG. 1F. The first adhesive applicator 115 is comprised of a first adhesive input 118 to supply the first adhesive 4, first nozzle 116 to transfer the first adhesive 4 to the tape substrate, first adhesive valve 117 to meter the adhesive volume applied through first nozzle 116, and first valve solenoid 119 to pulse the first adhesive valve to produce the first print area 137.

The second adhesive applicator 125 is comprised of a second adhesive input 128 to supply the second adhesive 5, second nozzle 126 to transfer the second adhesive 5 to the tape substrate, second adhesive valve 127 to meter the adhesive volume applied through first nozzle 126, and second valve solenoid 129 to pulse the second adhesive valve to produce the second print area 139.

The first print area 137 produced by the first adhesive applicator 115 is equal to or nearly equal to the spacing of the non-print area 138. The non-print area 138 is fully coated or nearly fully coated by the second adhesive applicator 125 to produce the second print area 135.

A continuous tape 10 (or 20, 30, 40, 50) may be made by the process shown in FIGS. 12A and 12B. FIGS. 12A and 12B show the tape substrate being pulled adjacent to the first nozzle 116 and second nozzle 126. The first print valve solenoid 119 and second valve solenoid 129 are made to collaborate by applicator controller 136 to coat the tape substrate with first adhesive 4 and second adhesive 5 such that the adhesives are coated adjacent or near adjacent to each other in creating the print in FIG. 1E or FIG. 1F.

FIGS. 12C and 12D show an embodiment in which the tape substrate has a first adhesive 4 and second adhesive 5 applied to create the print in FIG. 1G, 1H, or FIG. 1I. The first adhesive applicator 115 is comprised of a first adhesive input 118 to supply the first adhesive 4, first nozzle 116 to transfer the first adhesive 4 to the tape substrate, first adhesive valve 117 to meter the adhesive volume applied through first nozzle 116, and first valve solenoid 119 to regulate the first adhesive valve to produce the first print area 137.

The second adhesive applicator 125 is comprised of a second adhesive input 128 to supply the second adhesive 5, second nozzle 126 to transfer the second adhesive 5 to the tape substrate, second adhesive valve 127 to meter the adhesive volume applied through first nozzle 126, and second valve solenoid 129 to regulate the second adhesive valve to produce the print area 135. The first print area 137 produced by the first adhesive applicator 115 is equal to or nearly equal in width to the second print area 135 produced by the second adhesive applicator 125.

A continuous tape 10 (or 20, 30, 40, 50) may be made by the process shown in FIGS. 12C and 12D. FIGS. 12C and 12D show the tape substrate being pulled adjacent to the first nozzle 116 and second nozzle 126. The first print valve solenoid 119 and second valve solenoid 129 are made to collaborate by applicator controller 136 to coat the tape substrate with first adhesive 4 and second adhesive 5 such that the adhesives are coated adjacent or near adjacent to each other in creating the print in FIG. 1G, 1H, or FIG. 1I.

### Examples

The adhesive examples below were prepared in single blade mixer heated to 300° F. by mixing the components until homogeneous. The amount of the components shown below is based on the dry total weight of the composition.

### Adhesive #1

0.33% Antioxidant, 0.14% Blue dye, 30% Rosin Ester by Mead WestVaco Westerez 5101, 13% Hikotack P-120P Phenolic Resin, 5% Polyethylene Homopolymer Honeywell AC-6, 11% Paraffin Wax 140 melt point IGI 1240, 31.53% Ethylene Vinyl Acetate 2810 Atevea AT plastics, 9% Ethylene Vinyl Acetate 1880 Ateva AT Plastics.

### Adhesive #2:

### 0.33% Antioxidant BNX 1010, 0.14% Blue Dye Solvent Blue 35, 26.03% Komotac KF454s Guangdong Komo, 15% Hikotack P-110S, 17.5% Wax IGI 1240, 33% Dupont Elvax 260, 8% Dupont Elvax 150.

### Adhesive #3:

0.33% Antioxidant BNX 1010, 0.14% Blue Dye Solvent Blue 35 Paramount Colors, 32% Sylvatlite RE100L Arizona Chemical, 12% Sylvares TP2040 Arizona Chemical, 12% Marcus 300 Marcus Oil & Chemical, 2.53% Polywax 2000 Polyethylene Baker Petrolite, 5% AC-6 Polyethylene Hompolymer Honeywell, 9% Ethylene Vinyl Acetate Elvax 260, 27% Ethylene Vinyl Acetate Elvax 410.

### Adhesive #4:

0.33% Antioxidant BNX 1010, 0.14% Blue Dye Solvent Blue 35 Paramount Colors, 30% Komotack KF454S Guangdong Komo, 10% Hicotack P-120P Kolon Chemical, 5% AC-6 Polyethylene Hompolymer Honeywell, 2.53% Honeywell AC 820A Honeywell, 10% Marcus 200 Marcus Oil & Chemical, 1% Rubber, 14% SIS, 10% Coupled Kraton D1161K, 37% Ethylene Vinyl Acetate Ateva 2810.

### Adhesive #5:

0.33% Antioxidant Evernox 10GF, 0.14% Blue Dye Solvent Blue 35 Paramount Colors, 33.67% Sylvatlite RE100L Arizona Chemical, 12.86% Sylvares TP2040 Arizona Chemical, 12% Marcus 300 Marcus Oil & Chemical, 3% Polywax 2000 Polyethylene Baker Petrolite, 7% Ethylene Vinyl Acetate Elvax 410, 31% Ethylene Vinyl Acetate Elvax 260.

### Adhesive #6:

0.33% Antioxidant BNX 1010, 0.14% Blue Dye Solvent Blue 35 Paramount Colors, 32% Westrez 5101 Mead Westvaco, 12% Hicotack P-120P Kolon Chemical, 6% Marcus 300 Marcus Oil & Chemical, 2.5% Polywax 2000 Polyethylene Baker Petrolite, 5% Shell SX100 Baker Petrolite, 7% Ethylene Vinyl Acetate Ateva 1880A, 8.03% Ethylene Vinyl Acetate Elvax 150, 27% Ethylene Vinyl Acetate Ateva 2810.

### Adhesive #7:

0.33% Antioxidant Evernox 10GF, 0.14% Blue Dye Solvent Blue 35 Paramount Colors, 32% Sylvatlite RE100L Arizona Chemical, 12% Sylvares TP2040 Arizona Chemical, 5% AC-6 Polyethylene Hompolymer Honeywell, 2.53% Polywax 2000 Polyethylene Baker Petrolite, 6% Marcus 300 Marcus Oil & Chemical, 15% Ethylene Vinyl Acetate Elvax 410, 27% Ethylene Vinyl Acetate Elvax 260.

### Adhesive #8:

0.33% Antioxidant Evernox 10GF, 0.14% Blue Dye Solvent Blue 35 Paramount Colors, 32% Sylvatlite RE100L Arizona Chemical, 12% Sylvares TP2040 Arizona Chemical, 5% AC-6 Polyethylene Hompolymer Honeywell, 2.53% Polywax 2000 Polyethylene Baker Petrolite, 6% Marcus 300 Marcus Oil & Chemical, 27% Ethylene Vinyl Acetate Elvax 410, 15% Ethylene Vinyl Acetate Elvax 260.

### Adhesive #9:

0.5% Antioxidant Evernox 10GF, 0.2% Blue Dye Solvent Blue 35 Paramount Colors, 20% Westrez 5101 Mead Westvaco, 21% Hicotack P-120P Kolon Chemical, 10% Sasolwax H1, 15% Marcus 200 Marcus Oil & Chemical, 2.4% Honeywell AC 820A Honeywell, 30.9% Ethylene Vinyl Acetate Elvax 150.

### Adhesive #10:

0.33% Antioxidant BNX 1010, 0.14% Blue Dye Solvent Blue 35 Paramount Colors, 29.25% Westrez 5101 Mead Westvaco, 11% Hicotack P-120P Kolon Chemical, 5% AC-6 Polyethylene Hompolymer Honeywell, 4% Sasolwax H1, 11.53% Paraffin 1240, 24.75% Ethylene Vinyl Acetate Ateva 2810, 14% Ethylene Vinyl Acetate Ateva 1880A.

### Adhesive #11:

0.33% Antioxidant BNX 1010, 0.14% Blue Dye Solvent Blue 35 Paramount Colors, 29.25% Komotack KF454S Guangdong Komo, 11% Hicotack P-120P Kolon Chemical, 5% AC-6 Polyethylene Hompolymer Honeywell, 4% Shell SX100 Baker Petrolite, 11.53% Wax IGI Paraffin 1260A, 24.75% Ethylene Vinyl Acetate Ateva 2810, 14% Ethylene Vinyl Acetate Ateva 1880A.

### Adhesive #12:

0.33% Antioxidant Evernox 10GF, 0.14% Blue Dye Solvent Blue 35 Paramount Colors, 31.25% Sylvatlite RE100L Arizona Chemical, 11% Sylvares TP2040 Arizona Chemical, 5% AC-6 Polyethylene Hompolymer Honeywell, 2.53% Sasolwax H8, 19% Wax Sasolwax R4054, 25.75% Ethylene Vinyl Acetate Elvax 260, 14% Ethylene Vinyl Acetate Elvax 410.

### Adhesive #13:

0.33% Antioxidant BNX 1010, 0.14% Blue Dye Solvent Blue 35 Paramount Colors, 32% Westrez 5101 Mead Westvaco, 12% Hicotack P-120P Kolon Chemical, 9.53% Sasolwax C80, 5% AC-6 Polyethylene Hompolymer Honeywell, 27% Ethylene Vinyl Acetate Ateva 2810, 14% Ethylene Vinyl Acetate Ateva 1880A.

### Adhesive #14:

0.33% Antioxidant Evernox 10GF, 0.14% Blue Dye Solvent Blue 35 Paramount Colors, 33.5% Komotack KF454S Guangdong Komo, 7.53% Hicotack P-110S, 19.25% Shell SX100 Baker Petrolite, 27.25% Ethylene Vinyl Acetate Elvax 260, 12% Ethylene Vinyl Acetate Elvax 150.

### Adhesive #15:

0.33% Antioxidant BNX 1010, 0.14% Blue Dye Solvent Blue 35 Paramount Colors, 34% Sylvatlite RE100L Arizona Chemical, 10% Sylvares TP2040 Arizona Chemical, 9.53% Sasolwax H1, 5% AC-6 Polyethylene Hompolymer Honeywell, 27% Ethylene Vinyl Acetate Ateva 2810, 14% Ethylene Vinyl Acetate Ateva 3325.

### Adhesive #16:

0.33% Antioxidant Evernox 10GF, 0.14% Blue Dye Solvent Blue 35 Paramount Colors, 36% Komotack KF454S Guangdong Komo, 8% Hicotack P-1105, 5% AC-6 Polyethylene Hompolymer Honeywell, 9.53% Shell SX100 Baker Petrolite, 27% Ethylene Vinyl Acetate Elvax 260, 14% Ethylene Vinyl Acetate Elvax 150.

Adhesive #17:

0.33% Antioxidant Evernox 10GF, 0.14% Blue Dye Solvent Blue 35 Paramount Colors, 38% Komotack KF454S Guangdong Komo, 6% Hicotack P-110S, 9.53% Shell SX100 Baker Petrolite, 5% AC-6 Polyethylene Hompolymer Honeywell, 27% Ethylene Vinyl Acetate Elvax 260, 14% Ethylene Vinyl Acetate Elvax 150.

### Adhesive #18:

0.33% Antioxidant BNX 1010, 0.14% Blue Dye Solvent Blue 35 Paramount Colors, 40% Sylvatlite RE100L Arizona Chemical, 4% Sylvares TP2040 Arizona Chemical, 9.53% Sasolwax H1, 5% AC-6 Polyethylene Hompolymer Honeywell, 27% Ethylene Vinyl Acetate Ateva 2810, 14% Ethylene Vinyl Acetate Ateva 3325.

### Adhesive #19:

### 0.33% Antioxidant Evernox 10GF, 0.14% Blue Dye Solvent Blue 35 Paramount Colors, 20% Komotack KF454S Guangdong Komo, 17.53% Hicotack P-110S, 40% Shell SX100 Baker Petrolite, 10% Ethylene Vinyl Acetate Elvax 260, 12% Ethylene Vinyl Acetate Elvax 150.

### Adhesive #20:

0.33% Antioxidant BNX 1010, 0.14% Blue Dye Solvent Blue 35 Paramount Colors, 10% Sylvatlite RE100L Arizona Chemical, 12% Sylvares TP2040 Arizona Chemical, 40% Sasolwax H1, 5% AC-6 Polyethylene Hompolymer Honeywell, 12.53% Ethylene Vinyl Acetate Ateva 2810, 20% Ethylene Vinyl Acetate Ateva 3325.

### Adhesive #21:

0.33% Antioxidant BNX 1010, 0.14% Blue Dye Solvent Blue 35 Paramount Colors, 5% AC-6 Polyethylene Hompolymer Honeywell, 40% Westrez 5101 Mead Westvaco, 12% Alphachem SK-120, 10% Wax IGI Paraffin 1260A, 12.53% Rubber, 14% SIS, 14% Coupled Kraton D1161K, 20% Ethylene Vinyl Acetate Ateva 3325.

### Adhesive #22:

0.33% Antioxidant Evernox 10GF, 0.14% Blue Dye Solvent Blue 35 Paramount Colors, 5% AC-6 Polyethylene Hompolymer Honeywell, 23% Komotack KF454S Guangdong Komo, 9.53% Rubber, 14% SIS, 14% Coupled Kraton D1161K, 10% Ethylene Vinyl Acetate Elvax 410, 12% Honeywell AC 820A Honeywell, 40% Ethylene Vinyl Acetate Elvax 260.
The adhesives were tested to simulate potential commercial applications in a lab setting.

### Adhesive Tapes

Adhesive tapes were made with a polyester film as the tape substrate and the specific adhesive sections described below.

The adhesive properties were measured as follows:

Adhesive tape number 1 was composed of adhesive example 10 and adhesive example 12. Example adhesive 10 had a softening point of 89° C., a tack of 73° C., a viscosity of 8420 cPs @176 C, a compression tack of 208 gf and an activation temperature range of 71 to 98° C. Example adhesive 12 had a softening point of 93° C., a tack of 73° C., a viscosity of 9000 cPs @176 C, a compression tack of 196 gf and an activation temperature range of 71-102° C. Adhesive tape 1 had a weft bond strength of 0.65 kg, a thickness of 0.21 mm, a tensile of 12 kg and a width of 10 mm.

Adhesive tape number 2 was composed of adhesive example 11 and adhesive example 13. Example adhesive 11 had a softening point of 102° C., a tack of 73° C., a viscosity of 9150 cPs @ 176 C, a compression tack of 193 gf and an activation temperature range of 71-106° C. Example adhesive 13 had a softening point of 92° C., a tack of 75° C., a viscosity of 25810 cPs @ 176 C, a compression tack of 176 gf and an activation temperature range of 72-98° C. Adhesive tape 2 had a weft bond strength of 0.88 kg, a thickness of 0.30 mm, a tensile of 9 kg and a width of 12 mm.

Adhesive tape number 3 was composed of adhesive example 14 and adhesive example 15. Example adhesive 14 had a softening point of 107° C., a tack of 83° C., a viscosity of 10680 cPs @ 176 C, a compression tack of 180 gf and an activation temperature range of 81-110° C. Example adhesive 15 had a softening point of 107° C., a tack of 85° C., a viscosity of 10550 cPs @176 C, a compression tack of 224 gf and an activation temperature range of 79-110° C. Adhesive tape 3 had a weft bond strength of 0.65 kg, a thickness of 0.28 mm, a tensile of 19 kg and a width of 11 mm.

Adhesive tape number 4 was composed of adhesive example 12, adhesive example 14, and adhesive example 15. Example adhesive 12 had a softening point of 93° C., a tack of 73° C., a viscosity of 9000 cPs @ 176 C, a compression tack of 196 gf and an activation temperature range of 71-102° C. Example adhesive 14 had a softening point of 107° C., a tack of 83° C., a viscosity of 10680 cPs @ 176 C, a compression tack of 180 gf and an activation temperature range of 81-110° C. Example adhesive 15 had a softening point of 107° C., a tack of 85° C., a viscosity of 10550 cPs @ 176 C, a compression tack of 224 gf and an activation temperature range of 79-110° C. Adhesive tape 4 had a weft bond strength of 0.77 kg, a thickness of 0.19 mm, a tensile of 19 kg and a width of 11 mm.

Adhesive tape number 5 was composed of adhesive example 11 and adhesive example 12, and adhesive example 13. Example adhesive 11 had a softening point of 102° C., a tack of 73° C., a viscosity of 9150 cPs @ 176 C, a compression tack of 193 gf and an activation temperature range of 71-106° C. Example adhesive 12 had a softening point of 93° C., a tack of 73° C., a viscosity of 9000 cPs @ 176 C a compression tack of 196 gf and an activation temperature range of 71-102° C. Example adhesive 13 had a softening point of 92° C., a tack of 75° C., a viscosity of 25810 cPs @ 176 C, a compression tack of 176 gf and an activation temperature range of 72-98° C. Adhesive tape 5 had a weft bond strength of 0.63 kg, a thickness of 0.23 mm, a tensile of 21 kg and a width of 12 mm.

The properties were measured as follows:

ASTM D3236-88 (2009) Standard Test Method for Apparent Viscosity of Hot Melt Adhesives and Coating Materials is the standard used to measure viscosity in all instances where a viscosity measurement is provided. Melt viscosities of the hot melt adhesives were determined on a Brookfield Model RVT Thermosel viscometer using a number 27 spindle.

ASTM D3111-10 Standard Test Method for Determination of Hot-Melt Adhesives by Mandrel Bend Test Method is the standard used to determine flexibility requirements of HMA's.

ASTM D4497-10 Standard Test Method for Determining the Open Time of Hot Melt Adhesives is the standard for observing the open-time between a group of adhesives.

ASTM D3808-01 (2013) Standard Test Method for Qualitative Determination of Adhesion of Adhesives to Substrates by Spot Adhesion this test method covers a simple qualitative procedure for quickly screening whether an adhesive will, under recommended application conditions, bond to a given substrate without actually making bonded assemblies.

ASTM D638-10 Standard Test Method for Tensile Properties of Plastics is the standard for the determination of the tensile properties of unreinforced HMA's.

The term “bond strength” means the unit load applied to tension, compression, flexure, peel, impact, cleavage, or shear required to break an adhesive assembly with failure occurring in or near the plane of the bond.

The term “tack” is defined according to ASTM D 907 as the property of an adhesive that enables it to form a bond of measurable strength immediately after adhesive and an adherend are brought into contact under low pressure. Tack can be measured by cutting a 1″×8″×0.002″ sample of hot melt film and placing it on a gradient bar and placing a piece of paper over top, rolling the paper with light pressure and then removing at 90 degree angle. The area where the adhesive stops pulling fiber is considered the high end of the tack point. This is considered a qualitative test and does not have an associated quantitative measurement.

The compression tack of the adhesive formulations are measured by the ASTM Method D2979-01 “Standard Test Method for Pressure-Sensitive Tack of Adhesives Using an Inverted Probe Machine” using a steel rod probe of 5 mm diameter at 23° C. (herein “room temperature”). This compression tack number is used to correspond to the room temperature of the hot melt adhesive, which often has a “tacky feel” to it and which is considered a desirable characteristic. A “dry” hot melt adhesive refers to a hot melt adhesive with a low compression tack value where a “sticky” hot melt adhesive will have a relatively higher compression tack number.

ASTM D6090-12 Standard Test Method for Softening Point Resins (Mettler Cup and Ball Method) related to ASTM E28-99 (2009) Standard Test Methods for Softening Point of Resins Derived from Naval Stores by Ring-and-Ball Apparatus

In view of the many possible embodiments to which the principles of the disclosed methods and articles of manufacture may be applied, it should be recognized that the illustrated embodiments are only preferred examples of the invention and should not be taken as limiting the scope of the invention.

What is claimed is:

1. An adhesive tape or string, comprising:
a substrate having a first surface and an opposing second surface, and defining a longitudinal direction; and
an adhesive system comprising at least a first adhesive section and a second adhesive section, wherein the first adhesive section and the second adhesive section each contact the first surface of the substrate, and wherein the first adhesive section comprises a first heat-activatable hot melt adhesive having a first activation temperature range and a first set time and the second adhesive section comprises a second heat-activatable hot melt adhesive having a second activation temperature range and a second set time, and wherein:
the first activation temperature range is different than the second activation temperature range; or
the first set time is different than the second set time; or
the first activation temperature range is different than the second activation temperature range and the first set time is different than the second set time.

2. The tape or string of claim 1, wherein the first adhesive section has a first tack and the second adhesive section has a second tack that is different than the first tack.

3. The tape or string of claim 2, wherein the first adhesive section has a first tack of 68 to 80° C. and the second adhesive section has a second tack of 75 to 95° C.

4. The tape or string of claim 1, wherein the first adhesive section has a first softening point of 80 to 95° C., and the second adhesive section has a second softening point of 93 to 121° C.

5. The tape or string of claim 1, wherein the first adhesive section has a first tack range of 62 to 71° C. and the second adhesive section has a second tack range of 79 to 93° C.

6. The tape or string of claim 3, wherein the first adhesive section has a first softening point of 80 to 95° C., and the second adhesive section has a second softening point of 95 to 121° C., and the first adhesive section has a first tack range of 62 to 71° C. and the second adhesive section has a second tack range of 79 to 93° C.

7. The tape or string of claim 1, wherein the first activation temperature range and the second activation temperature range are each individually selected from: 60 to 71° C., 75 to 95° C., 105 to 120° C., 65 to 95° C., 60 to 75° C., 71 to 106° C., 95 to 120° C., or any range encompassed therein.

8. The tape or string of claim 6, wherein the first activation temperature range and the second activation temperature range are each individually selected from: 60 to 71° C., 75 to 95° C., 105 to 120° C., 65 to 95° C., 60 to 75° C., 71 to 106° C., 95 to 120° C., or any range encompassed therein.

9. The tape or string of claim 1, wherein the first activation temperature range is 60 to 71° C., and the second activation temperature range is 75 to 95° C.

10. The tape or string of claim 1, wherein the first activation temperature range is 60 to 71° C., and the second activation temperature range is 105 to 120° C.

11. The tape or string of claim 1, wherein the first activation temperature range is 65 to 95° C., and the second activation temperature range is 105 to 120° C.

12. The tape or string of claim 1, wherein the first set time and the second set time are each individually selected from: 1 to 3 seconds; 3 to 7 seconds; or 7 or more seconds.

13. The tape or string of claim 2, wherein the first set time and the second set time are each individually selected from: 1 to 3 seconds; 3 to 7 seconds; or 7 or more seconds.

14. The tape or string of claim 7, wherein there are a plurality of first adhesive sections and a plurality of second adhesive sections interspersed along the longitudinal direction of the substrate.

15. The tape or string of claim 14, wherein the sections each individually form a transversely-extending shape.

16. The tape or string of claim 1, wherein there are a plurality of first adhesive sections and a plurality of second adhesive sections arranged in alternating adjacent segments along the longitudinal direction of the substrate.

17. The tape or string of claim 16, wherein each segment forms a transversely-extending shape.

18. The tape or string of claim 1, wherein the substrate comprises fibers, a film, a cellulosic substrate, or a combination thereof.

19. The tape or string of claim 1, wherein the lowest temperature end point of the first activation temperature range and the second activation temperature range is up to 2-4° C. less than a lowest tack temperature of the first heat-activatable hot melt adhesive and the second heat-activatable hot melt adhesive, respectively, and the highest temperature end point of the first activation temperature range and the second activation temperature range is up to 2-10° C. above the softening point of the first heat-activatable hot melt adhesive and the second heat-activatable hot melt adhesive, respectively.

20. An adhesive tape or string for use in a corrugator system, comprising:
a substrate having a first surface and an opposing second surface, and defining a longitudinal direction; and
an adhesive system comprising at least a first adhesive section and a second adhesive section, wherein the first adhesive section and the second adhesive section each contact the first surface of the substrate, and wherein the first adhesive section comprises a first heat-activatable adhesive that can bond to a corrugated board substrate at a first temperature applied by the corrugator system, and a second heat-activatable adhesive that can bond to a corrugated board substrate at a second temperature applied by the corrugator system, wherein the first temperature is different than the second temperature.

21. The tape of string of claim 20, wherein the first temperature is selected from 150 to 185° C., 170 to 195° C., or 190 to 225° C., and the second temperature is selected from 170 to 190° C., 190 to 225° C., or 220 to 260° C.

22. A method for making a tape, comprising:
contacting a first surface of a tape substrate with a first print roll, wherein a first heat-activatable hot melt adhesive is present on a first print pattern on the circumference of the first print roll; and then
contacting the first surface of the tape substrate with a second print roll, wherein a second heat-activatable hot melt adhesive is present on a second print pattern disposed on the circumference of the second print roll, the second heat-activatable hot melt adhesive having a composition that is different than the first heat-activatable hot melt adhesive; wherein
the first print roll and the second print roll cooperate with each other to produce an adhesive tape having at least a first adhesive section of the first heat-activatable hot melt adhesive and a second adhesive section of the second heat-activatable hot melt adhesive, wherein the first adhesive section and the second adhesive section are each disposed on the first surface of the tape substrate.

23. A method for making a tape, comprising:
spraying or coating a first heat-activatable hot melt adhesive onto a first surface of a tape substrate; and then
spraying or coating a second heat-activatable hot melt adhesive onto the first surface of a tape substrate, the second heat-activatable hot melt adhesive having a composition that is different than the first heat-activatable hot melt adhesive,
so as to form an adhesive tape having at least a first adhesive section of the first heat-activatable hot melt adhesive and a second adhesive section of the second heat-activatable hot melt adhesive, wherein the first adhesive section and the second adhesive section are each disposed on the first surface of the substrate.
